(19) United States
(12) Patent Application Publication
(10) Pub. No.: US 2023/0401602 A1
(43) Pub. Date: Dec. 14, 2023

(54) RECONCILIATION OF COMMERCIAL MEASUREMENT RATINGS FOR NON-RETURN PATH DATA MEDIA DEVICES

(71) Applicant: The Nielsen Company (US), LLC, New York, NY (US)

(72) Inventors: David J. Kurzynski, Elgin, IL (US); Kimberly I. Gilberti, Tampa, FL (US); Kristin Meehan, Brooklyn, NY (US); Samantha M. Mowrer, La Grange, IL (US); Jiji Sadasivakurup, Tampa, FL (US); Lisa G. Rossi, Lutz, FL (US); Ramy Vasquez, St. Petersburg, FL (US)

(21) Appl. No.: 18/454,371

(22) Filed: Aug. 23, 2023

Related U.S. Application Data
(63) Continuation of application No. PCT/US2022/017947, filed on Feb. 25, 2022.
(60) Provisional application No. 63/153,764, filed on Feb. 25, 2021.

(51) Int. Cl. G06Q 30/0242; H04N 21/24; H04H 60/64

(52) U.S. Cl. CPC G06Q 30/0246; H04N 21/2407; H04H 60/64

(57) ABSTRACT

Methods, apparatus, systems, and articles of manufacture for reconciliation of commercial measurement ratings for non-return path data media devices are disclosed. Example apparatus disclosed herein are to estimate unreported addressable impressions for a plurality of unreported households for an addressable advertisement based on an impressions adjustment ratio of served reportable addressable impressions to exposed reported addressable impressions included in impressions data associated with reported households. Disclosed example apparatus are further to calculate at least one of reach or frequency for the addressable advertisement to account for non-reporting devices, the at least one of the reach or the frequency determined based on the exposed reported addressable impressions, the estimated unreported addressable impressions, and the impressions adjustment ratio.

### CROSS-REFERENCE TO RELATED APPLICATIONS

This disclosure is a continuation of International Patent Application No. PCT/US2022/017947, filed Feb. 25, 2022, which claims the benefit of U.S. Provisional Patent Application No. 63/153,764, filed on Feb. 25, 2021, each of which is hereby incorporated by reference in its entirety.

### FIELD OF THE DISCLOSURE

This disclosure relates generally to audience measurement, and, more particularly, to the reconciliation of commercial measurement ratings for non-return path data media devices.

### BACKGROUND

Audience measurement entities (AMEs), such as The Nielsen Company (US), LLC, may extrapolate audience viewership data for a total television viewing audience. The audience viewership data collected by an AME may include viewership data for advertisements broadcasted during television programs.

### BRIEF DESCRIPTION OF THE DRAWINGS

FIG. 1 is a block diagram of an example environment in which the teachings of this disclosure may be implemented.

FIG. 2 is a block diagram of example non-return path adjuster circuitry included in the example environment of FIG. 1.

FIG. 3 illustrates an example table including input addressable target file data.

FIGS. 4A and 4B illustrate example tables including return path data (RPD) addressable advertisements from the input addressable target file data.

FIG. 5 illustrates an example table including input tuning data from households.

FIG. 6 illustrates an example table including identifying household identifiers for assigning designated market area (DMA) to non-RPD data.

FIG. 7 illustrates an example table including assigning DMA households from reference zip code data.

FIGS. 8A and 8B illustrate example tables of impressions data for log level households and log level persons 2+.

FIGS. 9A and 9B illustrate example tables of the combined impressions data from the log level household impressions and log level persons 2+ impressions.

FIG. 9C illustrates an example table of calculated non-PRD/RPD ratio data based on the impressions data.

FIGS. 10A and 10B illustrate example tables of applying the ratio data of FIG. 9C to the aggregated impressions data.

FIGS. 10C and 10D illustrate example tables of determining total campaign impressions from the RPD/ACR and non-RPD/non-ACR impressions.

FIGS. 11A-11D illustrate example tables of calculating reach and frequency measurements.

FIG. 12 is a flowchart representative of example machine readable instructions and/or example operations that may be executed by example processor circuitry to implement the example non-return path adjuster circuitry of FIG. 2.

FIG. 13 is a block diagram of an example processing platform including processor circuitry structured to execute the example machine readable instructions and/or the example operations of FIG. 12 to implement the example non-return path adjuster circuitry of FIG. 2.

FIG. 14 is a block diagram of an example implementation of the processor circuitry of FIG. 13.

FIG. 15 is a block diagram of another example implementation of the processor circuitry of FIG. 13.

FIG. 16 is a block diagram of an example software distribution platform (e.g., one or more servers) to distribute software (e.g., software corresponding to the example machine readable instructions of FIG. 12) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein “substantially real time” refers to occurrence in a near instantaneous manner recognizing there may be real world delays for computing time, transmission, etc. Thus, unless otherwise specified, “substantially real time” refers to real time+/− 1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

As used herein, the term “media” includes any type of content and/or advertisement delivered via any type of distribution medium. Thus, media includes television programming or advertisements, radio programming or advertisements, movies, web sites, streaming media, etc. As used herein, the term “media asset” refers to any individual, collection, or portion/piece of media of interest. For example, a media asset may be a television show episode, a movie, a clip, etc. Media assets can be identified via unique media identifiers (e.g., a name of the media asset, a metadata tag, etc.). Media assets can be presented by any type of media presentation method (e.g., via streaming, via live broadcast, from a physical medium, etc.).

Example methods, apparatus, and articles of manufacture disclosed herein monitor media presentations by media devices. Such media devices may include, for example, Internet-enabled televisions, personal computers, Internet-enabled mobile handsets (e.g., a smartphone), video game consoles (e.g., Xbox®, PlayStation®), tablet computers (e.g., an iPad®), digital media players (e.g., a Roku® media player, a Slingbox®, etc.), etc.

In some examples, AMEs aggregate media monitoring information to determine ownership and/or usage statistics of media devices, determine the media presented by the media devices, determine audience ratings, determine relative rankings of usage and/or ownership of media devices, determine types of uses of media devices (e.g., whether a device is used for browsing the Internet, streaming media from the Internet, etc.), and/or determine other types of media device information. In examples disclosed herein, monitoring information includes, but is not limited to, one or more of media identifying information (e.g., media-identifying metadata, codes, signatures, watermarks, and/or other information that may be used to identify presented media), application usage information (e.g., an identifier of an application, a time and/or duration of use of the application, a rating of the application, etc.), and/or user-identifying information (e.g., demographic information, a user identifier, a panelist identifier, a username, etc.), etc.

In some examples, audio watermarking is used to identify media such as television broadcasts, radio broadcasts, advertisements (television and/or radio), downloaded media, streaming media, prepackaged media, etc. Existing audio watermarking techniques identify media by embedding one or more audio codes (e.g., one or more watermarks), such as media identifying information and/or an identifier that may be mapped to media identifying information, into an audio and/or video component. In some examples, the watermark is embedded in the audio or video component so that the watermark is hidden.

To identify watermarked media, the watermark(s) are extracted and used to access a table of reference watermarks that are mapped to media identifying information. In some examples, media monitoring companies provide watermarks and watermarking devices to media providers with which to encode their media source feeds. In some examples, if a media provider provides multiple media source feeds (e.g., ESPN and ESPN 2, etc.), a media provider can provide a different watermark for each media source feed.

In some examples, signature matching is used to identify media. Unlike media monitoring techniques based on watermarks included with and/or embedded in the monitored media, fingerprint or signature-based media monitoring techniques generally use one or more inherent characteristics of the monitored media during a monitoring time interval to generate a substantially unique proxy for the media. Such a proxy is referred to as a signature or fingerprint, and can take any form (e.g., a series of digital values, a waveform, etc.) representative of any aspect(s) of the media signal(s) (e.g., the audio and/or video signals forming the media presentation being monitored). A signature may be a series of signatures collected in series over a time interval. A good signature is repeatable when processing the same media presentation, but is unique relative to other (e.g., different) presentations of other (e.g., different) media. Accordingly, the terms “fingerprint” and “signature” are used interchangeably herein and are defined herein to mean a proxy for identifying media that is generated from one or more inherent characteristics of the media.

Signature-based media monitoring generally involves determining (e.g., generating and/or collecting) signature(s) representative of a media signal (e.g., an audio signal and/or a video signal) output by a monitored media device and comparing the monitored signature(s) to one or more references signatures corresponding to known (e.g., reference) media source feeds. Various comparison criteria, such as a cross-correlation value, a Hamming distance, etc., can be evaluated to determine whether a monitored signature matches a particular reference signature. When a match between the monitored signature and a reference signature is found, the monitored media can be identified as corresponding to the particular reference media represented by the reference signature that matched with the monitored signature. In some examples, signature matching is based on sequences of signatures such that, when a match between a sequence of monitored signatures and a sequence of reference signatures is found, the monitored media can be identified as corresponding to the particular reference media represented by the sequence of reference signatures that matched the sequence of monitored signatures. Because attributes, such as an identifier of the media, a presentation time, a broadcast channel, etc., are collected for the reference signature(s), these attributes may then be associated with the monitored media whose monitored signature matched the reference signature(s). Example systems for identifying media based on codes and/or signatures are long known and were first disclosed in Thomas, U.S. Pat. No. 5,481,294, which is hereby incorporated by reference in its entirety.

AMEs, such as The Nielsen Company (US), LLC, desire knowledge regarding how users interact with media devices such as smartphones, tablets, laptops, smart televisions, etc. AMEs may also be referred to as media monitoring entities, audience survey entities, etc. In some examples, AMEs monitor media presentations made at the media devices to, among other things, monitor exposure to advertisements, determine advertisement effectiveness, etc. AMEs can provide media meters to people (e.g., panelists) which can generate media monitoring data based on the media exposure of those users. Such media meters can be associated with a specific media device (e.g., a television, a mobile phone, a computer, etc.) and/or a specific person (e.g., a portable meter, etc.).

As noted above, AMEs extrapolate ratings metrics and/or other audience measurement data for a total television viewing audience from a relatively small sample of panelist households, also referred to herein as panel homes. The panel homes may be well studied and are typically chosen to be representative of an audience universe as a whole.

To help supplement panel data, an AME, such as The Nielsen Company (US), LLC, may reach agreements with pay-television provider companies to obtain the television tuning information derived from set top boxes, which is referred to herein, and in the industry, as return path data (RPD). Set-top box (STB) data includes all the data collected by the set-top box. STB data may include, for example, tuning events and/or commands received by the STB (e.g., power on, power off, change channel, change input source, start presenting media, pause the presentation of media, record a presentation of media, volume up/down, etc.). STB data may additionally or alternatively include commands sent to a content provider by the STB (e.g., switch input sources, record a media presentation, delete a recorded media presentation, the time/date a media presentation was started, the time a media presentation was completed, etc.), heartbeat signals, or the like. The set-top box data may additionally or alternatively include a household identification (e.g. a household ID) and/or a STB identification (e.g. a STB ID).

Return path data includes any data receivable at a media service provider (e.g., a such as a cable television service provider, a satellite television service provider, a streaming media service provider, a content provider, etc.) via a return path to the service provider from a media consumer site. As such, return path data includes at least a portion of the set-top box data. Return path data may additionally or alternatively include data from any other consumer device with network access capabilities (e.g., via a cellular network, the internet, other public or private networks, etc.). For example, return path data may include any or all of linear real time data from an STB, guide user data from a guide server, click stream data, key stream data (e.g., any click on the remote—volume, mute, etc.), interactive activity (such as Video On Demand) and any other data (e.g., data from middleware). RPD data can additionally or alternatively be from the network (e.g., via Switched Digital software) and/or any cloud-based data (such as a remote server digital video recorder (DVR)) from the cloud.

In some examples, AMEs, such as The Nielsen Company (US), LLC, produce commercial measurement ratings, such as the C3-C7 measurement ratings. The C3-C7 metric represents the average audience of national commercials within a given program, inclusive of three (C3) or seven (C7) days of time-shifted viewing. The C3-C7 metric provides commercial metrics regarding the average commercial minute (ACM) for broadcasts of linear advertisements during a program. In examples disclosed herein, an ACM is the average number of duration weighted impressions during the commercial minutes of a telecast. In some example, the C3-C7 metric is determined by calculating the duration weighted impressions for each commercial minute of a telecast by multiplying the number of commercial impressions during the program by the duration of the commercials airing in that minute. The C3-C7 metric then sums the duration weighted impression for the entire telecast and sums the commercial duration in seconds. The C3-C7 metric determines the ACM by dividing the total duration weighted impressions by the total commercial duration.

In examples disclosed herein, a linear advertisement is an advertisement scheduled for broadcasting during a specific program to all households tuned to that program. The C3-C7 metric is determined by the AME for the linear broadcasts using tuning data measurements collected from households during the period(s) of time that advertisement(s) was (were) broadcasted during a program.

However, the development of addressable advertisement insertion technology has changed the way commercial advertisements in telecasts are provided to at least some media devices in households. Households have experienced an increase in the use of smart televisions (Smart TVs) for presenting media. In examples disclosed herein, a Smart TV is a television that is able to connect to a network, such as the internet, and run applications. Smart TVs may also include technology that allows advertisers to push specific advertisements to targeted households. For example, addressable advertisement insertion technology can push specific advertisements to targeted households using media devices (e.g., non-RPD and/or non-Smart TV devices), set-top boxes (e.g., based on information conveyed by RPD from the set-top boxes), etc. In examples disclosed herein, an addressable advertisement is an advertisement that is shown to a specific media device in a household. In examples disclosed herein, a media device selected for an addressable advertisement will not present the linear advertisement originally scheduled for that time period in the program.

The addressable advertisement insertion technology allows different households to view different advertisements during the same block of time. Example commercial measurement ratings, such as the C3-C7 metric, may not differentiate between whether a household audience was presented a linear advertisement or an addressable advertisement while watching a program.

In some examples, the C3-C7 metric is reconciled to differentiate the ACM measurements for addressable advertisements and linear advertisements. The reconciled C3-C7 metric includes collecting program viewership data from household Smart TVs and integrating the program viewership data into the measurement data collected for a national panel of households. The program viewership data collected from each Smart TV device in each household represents the program or programs (or, more generally, media) each Smart TV device was tuned to during a measurement interval, reporting interval, etc. In some examples, the viewership data may be collected using automatic content recognition (ACR) techniques based on watermarks, fingerprinting, etc. The reconciled C3-C7 metric may additionally or alternatively include collecting viewership data through a television set-top-box and from RPD data. The reconciled C3-C7 metrics further includes obtaining reference data that indicates which devices were served a linear advertisement during a time that a program was broadcast, and which devices were served an addressable advertisement during that same time in the program broadcast. The reconciled C3-C7 metrics includes using both the program viewership data collected for the national panel and the reference data indicating which devices presented which advertisement as inputs to the modified C3-C7 metric.

In some examples, an advertiser may serve an addressable advertisement to a media device with a set-top-box or a Smart TV that is not return path capable (e.g., the AMEs do not receive any longitudinal behavioral data from the media device to inform the demographic assignment needed for audience measurement). Examples disclosed herein account for the serving of addressable advertisements to these devices (e.g., the non-RPD/ACR media devices) in order to determine the addressable audience measurements and ensure the addressable audience estimates are not understated.

Examples disclosed herein collect/receive behavioral tuning data from RPD set-top-boxes and/or ACR Smart TVs, which are matched to an addressable target file that is provided by a data partner (e.g., an advertisement provider). In examples disclosed herein, the addressable target file identifies which RPD and/or ACR devices were served an addressable advertisement, and when those devices were served the addressable advertisement. Examples disclosed herein use the collected RPD and ACR behavioral data to determine the audience for the served addressable advertisement. In examples disclosed herein, the addressable target file also contains observations for when an addressable advertisement was served to a non-RPD/non-ACR device, in addition to the RPD/ACR instances. Examples disclosed herein adjust commercial measurement ratings to account for audience measurements of addressable advertisements that are served to non-RPD/non-ACR devices and ensure the addressable audience measurement is not understated.

Examples disclosed herein obtain log level household impressions and log level persons 2+ impressions (e.g., impressions logged for audiences of 2 or more persons/individuals) for the addressable advertisements. Examples disclosed herein sum the impressions into categories, and breakout live media impressions from time-shifted (e.g., DVR) media impressions. Examples disclosed herein determine addressable advertisement impressions for non-RPD/non-ACR capable households based on data collected from households in the RPD/ACR capable footprint. In some examples, examples disclosed herein calculate a ratio of the non-RPD/non-ACR devices that were served the addressable advertisement to the RPD/ACR devices were served the addressable advertisement by designated market area (DMA) for Persons 2+ and households using the addressable target file. In such examples, addressable advertisement impressions for non-RPD/non-ACR capable households are accounted for based on the ratio of served vs. exposed households in the RPD/ACR capable footprint. For example, if 45% of the target households in the RPD/ACR capable footprint are exposed to the addressable advertisement, examples disclosed herein assume that 45% of the target households in the non-RPD/non-ACR capable footprint are also exposed. These allocations are also done by DMA for Persons 2+. In some examples, examples disclosed herein multiply the RPD/ACR impressions by the ratio to get non-RPD/non-ACR impressions. Examples disclosed herein apply the ratio to aggregated impressions at the DMA/day/hour/live/time-shifted level for households and Persons 2+. Examples disclosed herein sum the RPD/ACR impressions and the non-RPD/non-ACR impressions to get total addressable advertisement impressions. However, examples disclosed herein may use other calculations to determine the addressable advertisement impressions for non-RPD/non-ACR capable households and total addressable advertisement impressions.

Examples disclosed herein also calculate reach and frequency for addressable advertisements while accounting for non-RPD/non-ACR devices. Examples disclosed herein use sum of weight (SOW) metrics for RPD/ACR households for intab households (e.g., households supplying usable data) and for target households. In examples disclosed herein, SOW metrics estimate the number of individuals in the demographic break and geography area. Examples disclosed herein calculate the reach for addressable advertisements while accounting for non-RPD/non-ACR devices using the SOW metrics for RPD/ACR households for intab households and for target households. For example, examples disclosed herein may calculate a ratio of intab households using the sum of weight (SOW) metrics for RPD/ACR households for intab households and target households. Examples disclosed herein may apply the ratio to the SOW metrics data for non-RPD/non-ACR target households. Examples disclosed herein calculate the reach for the non-RPD/non-ACR households based on the sum of weight (SOW) metrics for RPD/ACR households for intab households and target households and the reach for RPD/ACR households. For example, examples disclosed herein may calculate the reach for non-RPD/non-ACR households by applying the ratio of intab households using the sum of weight (SOW) metrics for RPD/ACR households for intab households and target households to the reach for RPD/ACR households. Examples disclosed herein combine the total SOW metrics data for intab households, the impressions data, and reach data RPD/ACR and non-RPD/non-ACR households. Examples disclosed herein calculate the percent reach by dividing the total reach (RPD/ACR and non-RPD/non-ACR households) by the total SOW metrics data for intab households and multiplying by 100. Examples disclosed herein calculate the average frequency by dividing the sum of the total impressions (RPD/ACR and non-RPD/non-ACR households) over the total reach (RPD/ACR and non-RPD/non-ACR households). However, examples disclosed herein may use other calculations to determine the percent reach and average frequency for addressable advertisements while accounting for non-RPD/non-ACR devices.

Examples disclosed herein may be included in systems for the reconciliation of commercial measurement ratings disclosed in Kurzynski et al., US Patent Application Publication No. 2021/02586545 and PCT Patent Application Publication No. 2021/163483, which are hereby incorporated by reference in their entirety. For example, examples disclosed herein can be used to augment the reconciled C3-C7 measurements to include contributions of non-RPD/non-ACR devices as disclosed above. Alternatively, the systems for the reconciliation of commercial measurement ratings can be revised to include reach and frequency measurements as disclosed above.

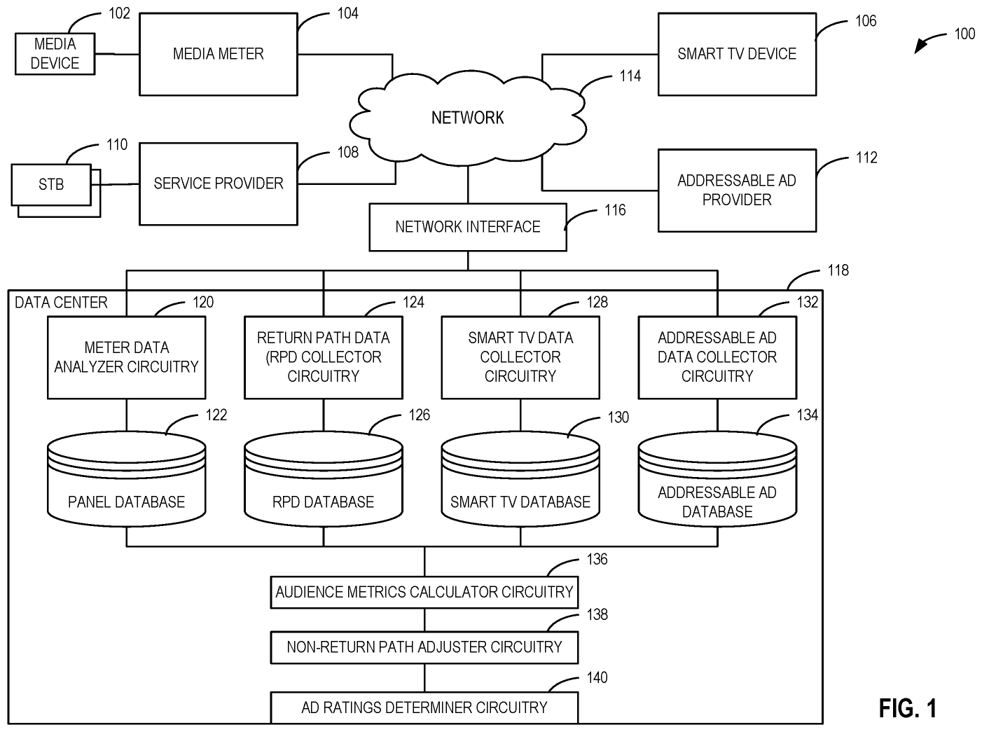

FIG. 1 is a block diagram of an example environment 100 in which the teachings of this disclosure may be implemented. The environment 100 includes an example media device 102, an example media meter 104, an example Smart TV device 106, an example service provider 108, example set top boxes (STBs) 110, an example addressable advertisement (ad) provider 112, an example network 114, an example network interface 116, and an example data center 118. The data center 118 further includes example meter data analyzer circuitry 120, an example panel database 122, example return path data (RPD) collector circuitry 124, an example RPD database 126, example Smart TV data collector circuitry 128, an example Smart TV database 130, example addressable ad data collector circuitry 132, an example addressable ad database 134, example audience metrics calculator circuitry 136, example non-return path adjuster circuitry 138, and example ad ratings determiner circuitry 140.

The example media device 102 is used to access and view different media. The example the media device 102 can be implemented with any device or combinations of devices that are able to connect to media such as, for example, a smart television (TV), a set-top box (STB), a game console, a digital video recorder (DVR), an Apple TV, a Roku device, YouTube TV, an Amazon fire device, other over-the-top (OTT) devices, etc., or any combination thereof.

The example media meter 104 collects media monitoring information from the media device 102. In some examples, the media meter 104 is associated with (e.g., installed on, coupled to, etc.) the example media device 102. For example, the media device 102 associated with the media meter 104 presents media (e.g., via a display, etc.). In some examples, the media device 102 that is associated with the media meter 104 additionally or alternatively presents the media on separate media presentation equipment (e.g., speakers, a display, etc.). In such examples, the media meter 104 can have direct connections (e.g., physical connections) to the media device 102, and/or may connect/communicate wirelessly (e.g., via Wi-Fi, via Bluetooth, etc.) with the media device 102.

Additionally or alternatively, in some examples, the media meter 104 is a portable meter carried by one or more individual people. In the illustrated example, the media meter 104 monitors media presented to one or more people associated with the media meter 104 and generates monitoring data. In some examples, the monitoring data generated by the media meter 104 can include watermarks and/or signatures associated with the presented media. For example, the media meter 104 can determine a watermark (e.g., generate watermarks, extract watermarks, etc.) and/or a signature (e.g., generate signatures, extract signatures, etc.) associated with the presented media. Accordingly, the monitoring data can include media signatures and/or media watermarks representative of the media monitored by the media meter 104. In some examples, the media meter 104 provides the monitoring data to the data center 118 via the example network 114.

The example Smart TV device 106 is a television that is able to connect to a network, such as the internet, and run applications. The example Smart TV device 106 may also include technology that allows advertisers to push specific advertisements to targeted households. In some examples, the Smart TV device 106 includes technology (e.g., an automatic content recognition (ACR) chip) for determining what media (e.g., an advertisement, television show, etc.) is presented on the Smart TV device 106. For example, the Smart TV device 106 may include an ACR chip that takes a picture of what is presented on the screen periodically (e.g., once every two second, once every ten seconds, etc.). In some such examples, the ACR chip in the Smart TV device 106 uses a reference library to perform matching through image fingerprinting (e.g., comparing a compressed screen shot of the media on the screen to image fingerprints stored in the reference library). The Smart TV device 106 determines what media is presented on the screen of the Smart TV device 106. In some examples, the Smart TV device 106 provides the identified media from the image fingerprinting to the data center 118 via the example network 114.

In the illustrated example of FIG. 1, the example service provider 108 collects return path data from the example STBs 110 in households. In some examples, the example STBs 110 generates data that may include, for example, tuning events and/or commands received by the STBs 110 (e.g., power on, power off, change channel, change input source, start presenting media, pause the presentation of media, record a presentation of media, volume up/down, etc.). The data from the example STBs 110 may additionally or alternatively include commands sent to a content provider by the STBs 110 (e.g., such as one or more commands to switch input sources, record a media presentation, delete a recorded media presentation, etc., and/or data related to one or more commands, such as the time/date a media presentation was started, the time a media presentation was completed, etc.), heartbeat signals, or the like. The data from the STB s 110 may additionally or alternatively include a household identification (e.g., a household ID) and/or a STB identification (e.g., a STB ID). The example service provider 108 collects return path data from the data of the STB s 110. The example service provider 108 may include a cable television service provider, a satellite television service provider, a streaming media service provider, a content provider, etc. In some examples, the return path data collected by the service provider 108 includes any or all of linear real time data from an STB, guide user data from a guide server, click stream data, key stream data (e.g., any click on the remote—volume, mute, etc.), interactive activity (such as Video On Demand, time-shifting/DVR usage, etc.) and any other data (e.g., data from middleware). In some examples, the service provider 108 provides the return path data to the data center 118 via the example network 114.

The example addressable ad provider 112 is an advertisement provider that provides addressable advertisements to selected households. The example addressable ad provider 112 pushes specific advertisements to targeted households (e.g., a household with demographic information that indicates there is a baby in the household may be targeted to receive a diaper advertisement instead of a car advertisement). In examples disclosed herein, an addressable advertisement is an advertisement that is shown to a specific media device in a household. The example addressable ad provider 112 identifies the target households for specific advertisements for different times (e.g., minutes) during a telecast. In some examples, the addressable ad provider 112 provides data (e.g., an addressable target file) identifying households that were provided and/or received the different addressable advertisements at the different times during a telecast to the data center 118 via the example network 114.

The example network 114 is a network used to transmit the monitoring data, Smart TV data, return path data, and addressable advertisement data to the example data center 118 via the network interface 116. In some examples, the network 114 can be the Internet or any other suitable external network. In other examples, any other suitable means of transmitting the monitoring data, Smart TV data, return path data, and addressable advertisement data to the data center 118 can be used.

The example data center 118 is an execution environment used to implement the example meter data analyzer circuitry 120, the example panel database 122, the example RPD collector circuitry 124, the example RPD database 126, the example Smart TV data collector circuitry 128, the example Smart TV database 130, the example addressable ad data collector circuitry 132, the example addressable ad database 134, the example audience metrics calculator circuitry 136, and the example ad ratings determiner circuitry 140. In some examples, the data center 118 is associated with a AME. In some examples, the data center 118 can be a physical processing center (e.g., a central facility of the AME, etc.). Additionally or alternatively, the data center 118 can be implemented via a cloud service (e.g., AWS™, etc.). The example data center 118 of FIG. 1 may be instantiated (e.g., creating an instance of, bring into being for any length of time, materialize, implement, etc.) by processor circuitry such as a central processing unit executing instructions. Additionally or alternatively, the example data center 118 of FIG. 1 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 1 may, thus, be instantiated at the same or different times. Some or all of the circuitry may be instantiated, for example, in one or more threads executing concurrently on hardware and/or in series on hardware. Moreover, in some examples, some or all of the circuitry of FIG. 1 may be implemented by one or more virtual machines and/or containers executing on the microprocessor.

In the illustrated example of FIG. 1, the meter data analyzer circuitry 120 collects, via the network interface 116 in communication with the example network 114, the monitoring data from one or more media meters, such as the example media meter 104, which monitor media exposure associated with media devices, such as the example media device 102 (e.g., televisions, radios, computers, tablet devices, smart phones, etc.), in panel homes recruited by an AME. The example meter data analyzer circuitry 120 processes the gathered media monitoring data to detect, identify, credit, etc. respective media assets and/or portions thereof (e.g., media segments) associated with the corresponding monitoring data. For example, the meter data analyzer circuitry 120 can compare the monitoring data to available reference data to determine what respective media assets and/or media segments are associated with the corresponding monitoring data. In some examples, the meter data analyzer circuitry 120 can hash the signatures included in the monitoring data. In some examples, the meter data analyzer circuitry 120 can identify the media by matching unhashed signatures and/or hashed signatures. In some examples, the meter data analyzer circuitry 120 can identify media by matching watermarks, and/or contents (e.g., payload, timestamps, etc.) thereof, included in the monitoring data to reference watermarks, and/or contents thereof, that are mapped to media identifying information. The meter data analyzer circuitry 120 of the illustrated example also analyzes the monitoring data to determine if a media asset, and/or particular portion(s) (e.g., segment(s)) thereof, is to be credited as a media exposure represented in the monitoring data. The example meter data analyzer circuitry 120 stores the identified monitoring data as panel data (e.g., monitoring data associated with panel households) along with additional panel household information (e.g., demographic information, geographic location, etc.) from the media meter 104 in the example panel database 122.

The example RPD collector circuitry 124 collects, via the network interface 116 in communication with the example network 114, the return path data from the example service provider 108 for associating with the example STBs 110. The RPD collector circuitry 124 stores the return path data along with additional household information (e.g., demographic information, geographic location, etc.) from the STBs 110 in the example RPD database 126.

The example Smart TV data collector circuitry 128 collects, via the network interface 116 in communication with the example network 114, the Smart TV data from the example Smart TV device 106 for monitoring media exposure associated with the example Smart TV device 106 households. The Smart TV data collector circuitry 128 stores the Smart TV data along with additional household information (e.g., demographic information, geographic location, etc.) from the Smart TV device 106 in the example Smart TV database 130.

The example addressable ad data collector circuitry 132 collects, via the network interface 116 in communication with the example network 114, the addressable advertisement data from the example addressable ad provider 112 for monitoring addressable advertisement exposure associated with media devices in target households. The addressable ad data collector circuitry 132 stores the addressable advertisement data along with additional household information (e.g., demographic information, geographic location, etc.) for the household(s) selected by the addressable ad provider 112 in the example addressable ad database 134. In some examples, the addressable ad data collector circuitry 132 stores the addressable advertisement data in an addressable target file. In examples disclosed herein, the addressable target file identifies which RPD or ACR devices were served a particular addressable advertisement, and when those devices were served the addressable advertisement. In some examples, the audience metrics calculator circuitry 136 use the collected RPD and ACR behavioral data to determine the audience for a served addressable advertisement. In examples disclosed herein, the addressable target file also contains observations for when an addressable advertisement was served to a non-RPD/non-ACR device, in addition to the RPD/ACR instances.

The example audience metrics calculator circuitry 136 obtains the panel data, return path data, Smart TV data, and reference advertisement data (e.g., the addressable target file) from the example panel database 122, the example RPD database 126, the example Smart TV database 130, and the example addressable ad database 134, respectively. The audience metrics calculator circuitry 136 combines the panel data, the return path data, the Smart TV data, and the reference advertisement data. The audience metrics calculator circuitry 136 analyzes the combined panel data, the return path data, the Smart TV data, and the reference advertisement data by identifying data associated with advertisement exposure (linear advertisements and addressable advertisements), removing duplicate data, etc. The example audience metrics calculator circuitry 136 identifies respondents that received addressable advertisements and respondents that received linear advertisements for the RPD and ACR media devices from the combined and analyzed panel data, the return path data, the Smart TV data, and the reference advertisement data. The example audience metrics calculator circuitry 136 calculates audience metrics (e.g., impressions, audience sizes, etc.) for RPD and ACR media devices in a telecast that were addressable advertisements and linear advertisements.

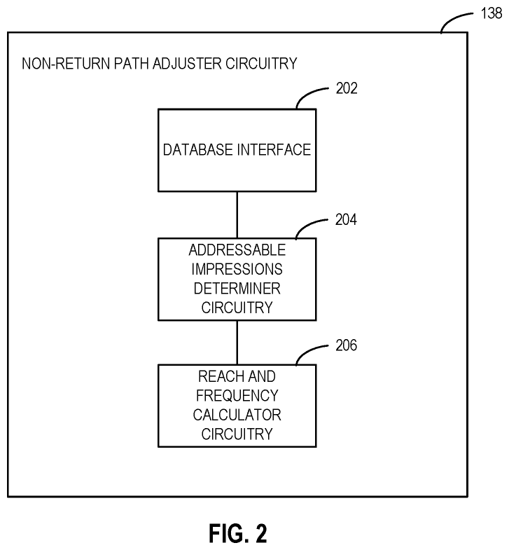

The example non-return path adjuster circuitry 138 of FIG. 1 adjusts commercial measurement ratings to account for audience measurements of addressable advertisements that are served to non-RPD/non-ACR devices (e.g., a media device with a set-top-box or a Smart TV that is not return path capable). In examples disclosed herein, non-RPD/non-ACR devices can be referred to as not reporting capable devices and/or unreported devices, which can include non-RPD/non-ACR capable devices and devices not authorized for reporting by the audience member/household. The example non-return path adjuster circuitry 138 obtains log level household impressions and log level persons 2+ impressions for addressable advertisements for reporting capable (RPD/ACR) devices included in the panel data, return path data, Smart TV data, and reference advertisement data (e.g., the addressable target file) from the example panel database 122, the example RPD database 126, the example Smart TV database 130, and the example addressable ad database 134, respectively. As used herein, log level household impressions are impressions logged at a household level granularity, and log level persons 2+ impressions are impressions logged for audiences of 2 or more persons/individuals. The example non-return path adjuster circuitry 138 sums/combines the impressions into categories, and breaks out live media impressions from time-shifted (e.g., nonlinear, DVR, etc.) media impressions. In some examples, the example non-return path adjuster circuitry 138 calculates an impressions adjustment ratio to account for the non-RPD/non-ACR devices that were served the addressable advertisement using data from the RPD/ACR devices that were served the addressable advertisement. In examples disclosed herein, RPD/ACR devices can be referred to as reporting capable devices and/or reported devices, which can include RPD and ACR capable devices authorized for reporting by the audience member/household. In some examples, the example non-return path adjuster circuitry 138 calculates the impressions adjustment ratio by designated market area (DMA) for Persons 2+ and households level impressions using the addressable target file from the example addressable ad database 134. In some examples, the example non-return path adjuster circuitry 138 calculates the impressions adjustment ratio by dividing the number target RPD/ACR capable households included in the addressable target file to be served the addressable advertisement by the number of RPD/ACR capable households that were exposed to the addressable advertisement based on the impressions data included in the panel data, return path data, and/or Smart TV data. In such examples, addressable advertisement impressions for non-RPD/non-ACR capable households are accounted for based on the ratio of served vs. exposed households in the RPD/ACR capable footprint. In some examples, the example non-return path adjuster circuitry 138 multiplies the RPD/ACR impressions (e.g., impressions associated with RPD and/or ACR media devices) determined by the example audience metrics calculator circuitry 136 by the impressions adjustment ratio to estimate non-RPD/non-ACR impressions (e.g., impressions associated with non-RPD and/or non-ACR devices). The example non-return path adjuster circuitry 138 sums/combines the RPD/ACR impressions and the non-RPD/non-ACR impressions to get total addressable advertisement impressions. The example non-return path adjuster circuitry 138 is described in further detail below in connection with FIG. 2.

The example ad ratings determiner circuitry 140 determines ratings data and/or other audience metrics by using audience metrics data from the audience metrics calculator circuitry 136 and the non-return path adjuster circuitry 138. In some examples, the ad ratings determiner circuitry 140 can use the ratings data to select addressable advertisements for respondents, modify the linear advertisements and addressable advertisements, disable addressable advertisements for target respondents, etc. In some examples, the ratings data and/or other audience metrics determined by the ad ratings determiner circuitry 140 can feedback to the example addressable ad provider 112 to adjust the—23−stimate—23 —lee advertisements provided to the different devices (e.g., RPD/ACR devices and non-RPD/non-ACR devices). In some examples, the ad ratings determiner circuitry 140 generates a report including data metrics regarding media exposure events for advertisements (linear and addressable) during a telecast that may be presented to media providers and advertisers.

FIG. 2 is a block diagram of the example non-return path adjuster circuitry 138 of FIG. 1 to reconcile commercial measurement ratings for non-return path data media devices. The example non-return path adjuster circuitry 138 of FIG. 2 may be instantiated (e.g., creating an instance of, bring into being for any length of time, materialize, implement, etc.) by processor circuitry such as a central processing unit executing instructions. Additionally or alternatively, the example non-return path adjuster circuitry 138 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by one or more virtual machines and/or containers executing on the microprocessor.

In the illustrated example, the non-return path adjuster circuitry 138 of FIG. 1 includes an example database interface 202 to obtain impressions data. The example database interface 202 obtains log level household impressions and log level persons 2+ impressions for addressable advertisements for the reporting capable (RPD/ACR) devices included in the panel data, return path data, Smart TV data, and reference advertisement data (e.g., the addressable target file) from the example panel database 122, the example RPD database 126, the example Smart TV database 130, and the example addressable ad database 134, respectively. The database interface 202 analyzes the panel data, return path data, the Smart TV data, and the reference advertisement data by identifying data associated with addressable advertisements exposure associated with RPD/ACR media devices, removing duplicate data, etc. The example database interface 202 combines the impressions data and separates the impressions data into live impressions and DVR impressions for addressable advertisements.

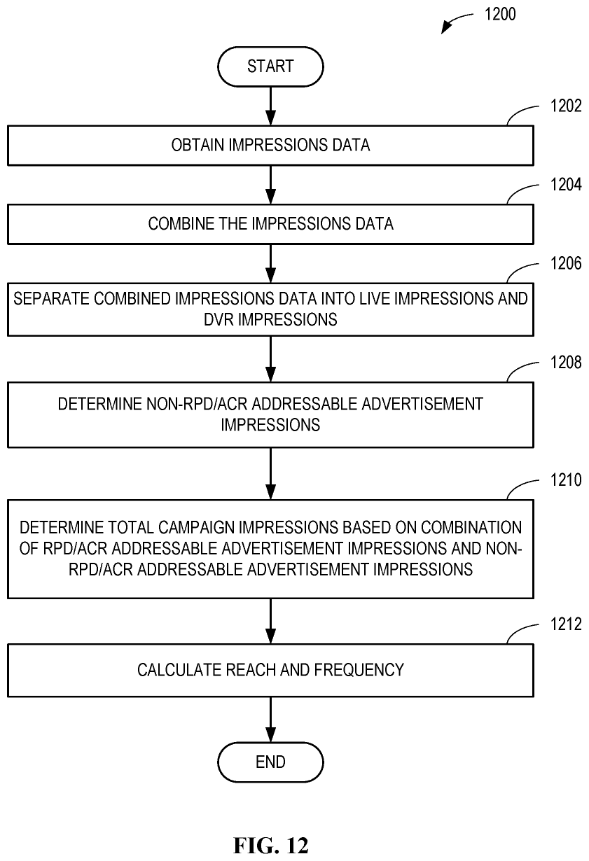

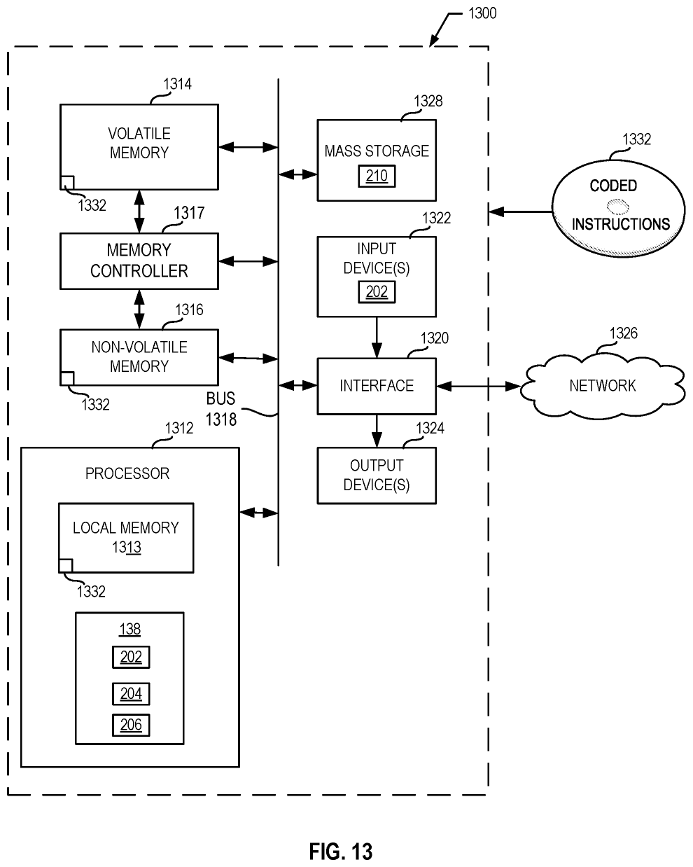

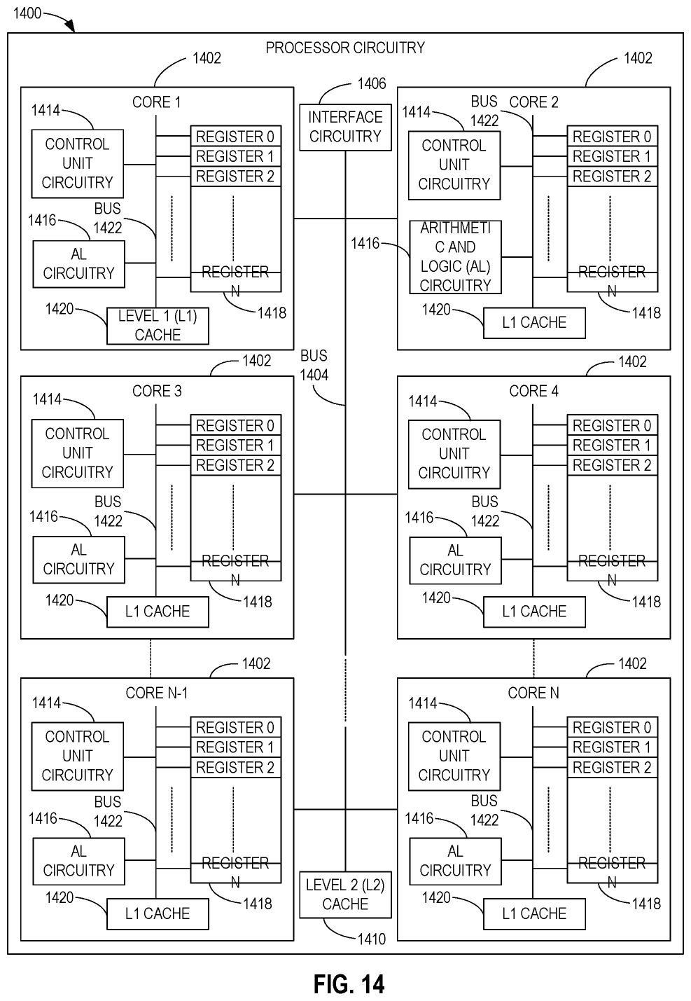

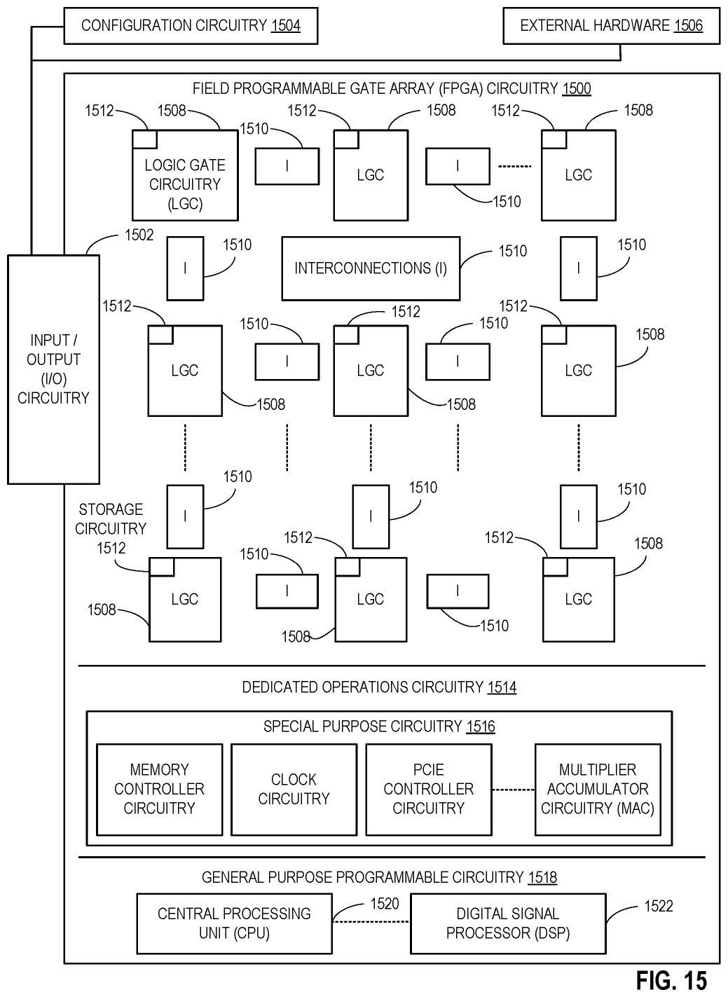

In some examples, the example non-return path adjuster circuitry 138 includes means for obtaining impressions data. For example, the means for obtaining may be implemented by the example database interface 202. In some examples, the database interface 202 may be instantiated by processor circuitry such as the example processor circuitry 1312 of FIG. 13. For instance, the database interface 202 may be instantiated by the example general purpose processor circuitry 1400 of FIG. 14 executing machine executable instructions such as that implemented by at least blocks 1202, 1204, 1206 of FIG. 12. In some examples, database interface 202 may be instantiated by hardware logic circuitry, which may be implemented by an ASIC or the FPGA circuitry 1500 of FIG. 15 structured to perform operations corresponding to the machine readable instructions. Additionally or alternatively, the database interface 202 may be instantiated by any other combination of hardware, software, and/or firmware. For example, the database interface 202 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example non-return path adjuster circuitry 138 of FIG. 1 further includes example addressable impressions determiner circuitry 204 to determine addressable advertisement impressions for non-RPD/non-ACR capable households. The example addressable impressions determiner circuitry 204 determines the non-RPD/non-ACR addressable advertisement impressions from the example the impressions data identified by the example database interface 202 for RPD/ACR devices. The example addressable impressions determiner circuitry 204 calculates an impressions adjustment ratio to determine the non-RPD/non-ACR impressions (e.g., impressions associated with not reporting capable devices (non-RPD and/or non-ACR devices)). In some examples, the addressable impressions determiner circuitry 204 calculates the impressions adjustment ratio using the RPD/ACR impressions (e.g., impressions associated with RPD and/or ACR media devices) determined by the example audience metrics calculator circuitry 136 of FIG. 1. In some examples, the addressable impressions determiner circuitry 204 calculates the impressions adjustment ratio by designated market areas (DMAs) for Persons 2+ and households level impressions. The example addressable impressions determiner circuitry 204 calculates the impressions adjustment ratio based on the served vs. exposed households in the RPD/ACR capable footprint. For example, the addressable impressions determiner circuitry 204 calculates the impression adjustment ratio using Equation 1 below.

$$( Equation 1 )$$

$$impressions adjustment ratio = \frac{served RPD / ACR households}{exposed RPD / ACR households}$$

In Equation 1 above, the example “served RPD/ACR households” are the number target RPD/ACR capable households included in the addressable target file from the example addressable ad provider 112 of FIG. 1 that were targeted to be served the addressable advertisement, and the example “exposure RPD/ACR households” are the number of RPD/ACR capable households that were actually exposed to the addressable advertisement based on the impressions data included in the panel data, return path data, and/or Smart TV data. The example addressable impressions determiner circuitry 204 determines the non-RPD/non-ACR addressable advertisement impressions by applying the calculated impressions adjustment ratio to the aggregated RPD/ACR addressable advertisement impressions. For example, the addressable impressions determiner circuitry 204 multiplies the aggregated RPD/ACR impressions by the impressions adjustment ratio to determine the non-RPD/non-ACR addressable advertisement impressions. For example, if 45% of the target households in the RPD/ACR capable footprint are exposed to the addressable advertisement (e.g., the calculated impressions adjustment ratio is 0.45 or 45%), the example addressable impressions determiner circuitry 204 determines that 45% of the target households in the non-RPD/non-ACR capable footprint are also exposed. However, the example addressable impressions determiner circuitry 204 may use other calculations to determine the non-RPD/non-ACR addressable advertisement impression. In some examples, addressable impressions determiner circuitry 204 applies the calculated impressions adjustment ratio to the aggregated RPD/ACR addressable advertisement impressions at the DMA/day/hour/live/TIME-SHIFTED (e.g., DVR) levels (e.g., RPD/ACR addressable advertisement impressions segmented into groups based on DMA, day, hour, live, time-shifted, etc.) for households and persons 2+ log levels.

In some examples, the addressable impressions determiner circuitry 204 determines total campaign impressions for addressable advertisements based on the combination of RPD/ACR addressable advertisement impressions and the determined non-RPD/ACR addressable advertisement impressions. The example addressable impressions determiner circuitry 204 sums/combines the measured RPD/ACR impressions and the estimated/determined non-RPD/non-ACR impressions to determine the total addressable advertisement impressions.

In some examples, the example non-return path adjuster circuitry 138 includes means for determining addressable advertisement impressions for non-RPD/non-ACR capable households. For example, the means for determining may be implemented by the example addressable impressions determiner circuitry 204. In some examples, the addressable impressions determiner circuitry 204 may be instantiated by processor circuitry such as the example processor circuitry 1312 of FIG. 13. For instance, the addressable impressions determiner circuitry 204 may be instantiated by the example general purpose processor circuitry 1400 of FIG. 14 executing machine executable instructions such as that implemented by at least blocks 1208, 1210 of FIG. 12. In some examples, the addressable impressions determiner circuitry 204 may be instantiated by hardware logic circuitry, which may be implemented by an ASIC or the FPGA circuitry 1500 of FIG. 15 structured to perform operations corresponding to the machine readable instructions. Additionally or alternatively, the addressable impressions determiner circuitry 204 may be instantiated by any other combination of hardware, software, and/or firmware. For example, the addressable impressions determiner circuitry 204 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example non-return path adjuster circuitry 138 of FIG. 1 includes example reach and frequency calculator circuitry 206 to calculate the reach and frequency for addressable advertisements while accounting for non-RPD/non-ACR devices. The example reach and frequency calculator circuitry 206 calculates the reach and frequency based on the RPD/ACR impressions, the determined non-RPD/ACR impressions, and impressions adjustment ratio. In some examples, the reach and frequency calculator circuitry 206 uses sum of weight (SOW) metrics for RPD/ACR households for intab households (e.g., supplying usable data) and for target households. In examples disclosed herein, SOW metrics estimate the number of individuals in the demographic break and geography area. In such examples, the reach and frequency calculator circuitry 206 calculate the reach for addressable advertisements while accounting for non-RPD/non-ACR devices using the SOW metrics for RPD/ACR households for intab households and for target households. In some examples, the example reach and frequency calculator circuitry 206 calculates an intab household ratio of RPD/ACR households. For example, the example reach and frequency calculator circuitry 206 may calculate the intab household ratio using example Equation 2 below.

$$intab household ratio = \frac{RPD / ACR intab household SOW}{RPD / ACR target household SOW} \qquad ( Equation 2 )$$

In the example Equation 2, “RPD/ACR intab household SOW” are the SOW metrics for RPD/ACR intab households, and “RPD/ACR target household SOW” are the SOW metrics for the RPD/ACR target households. In some examples, the reach and frequency calculator circuitry 206 applies (e.g., multiplies) the calculated intab household ratio to the SOW metrics for the non-RPD/non-ACR target households included in the addressable target file to determine the SOW metrics for the non-RPD/non-ACR intab households. The example reach and frequency calculator circuitry 206 determines a non-RPD/non-ACR reach based on the intab household ratio and the RPD/ACR reach (e.g., number of impressions from unique audience members in the RPD/ACR impressions data). The example reach and frequency calculator circuitry 206 multiplies the intab household ratio and the RPD/ACR reach to determine the non-RPD/non-ACR reach. In some examples, the example reach and frequency calculator circuitry 206 sums/combines the determined SOW intab metrics, impressions, and reaches across RPD/ACR households and non-RPD/non-ACR households.

The example reach and frequency calculator circuitry 206 determines the reach percentage using example Equation 3 below.

$$Reach \% = \frac{total reach}{total SOW intab} * 100 \qquad ( Equation 3 )$$

In the example Equation 3 above, the “total reach” is the sum of the reaches across RPD/ACR and non-RPD/non-ACR households, and the “total SOW intab” is the sum of the SOW intab metrics data for RPD/ACR intab households and non-RPD/non-ACR intab households. In some examples, the example reach and frequency calculator circuitry 206 determines the average frequency using example Equation 4 below.

$$Average Frequency = \frac{total impressions}{total reach} \qquad ( Equation 4 )$$

In the example Equation 4 above, the “total impressions” is the sum of total impressions (RPD/ACR and non-RPD/non-ACR), and the “total reach” is the sum of the reaches across RPD/ACR and non-RPD/non-ACR households. However, the example reach and frequency calculator circuitry 206 may use other calculations to determine the percent reach and average frequency.

In some examples, the example non-return path adjuster circuitry 138 includes means for calculating the reach and frequency for addressable advertisements to account for non-RPD/non-ACR devices. For example, the means for calculating may be implemented by the example reach and frequency calculator circuitry 206. In some examples, the reach and frequency calculator circuitry 206 may be instantiated by processor circuitry such as the example processor circuitry 1312 of FIG. 13. For instance, the reach and frequency calculator circuitry 206 may be instantiated by the example general purpose processor circuitry 1400 of FIG. 14 executing machine executable instructions such as that implemented by at least blocks 1212 of FIG. 12. In some examples, the reach and frequency calculator circuitry 206 may be instantiated by hardware logic circuitry, which may be implemented by an ASIC or the FPGA circuitry 1500 of FIG. 15 structured to perform operations corresponding to the machine readable instructions. Additionally or alternatively, the reach and frequency calculator circuitry 206 may be instantiated by any other combination of hardware, software, and/or firmware. For example, the reach and frequency calculator circuitry 206 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

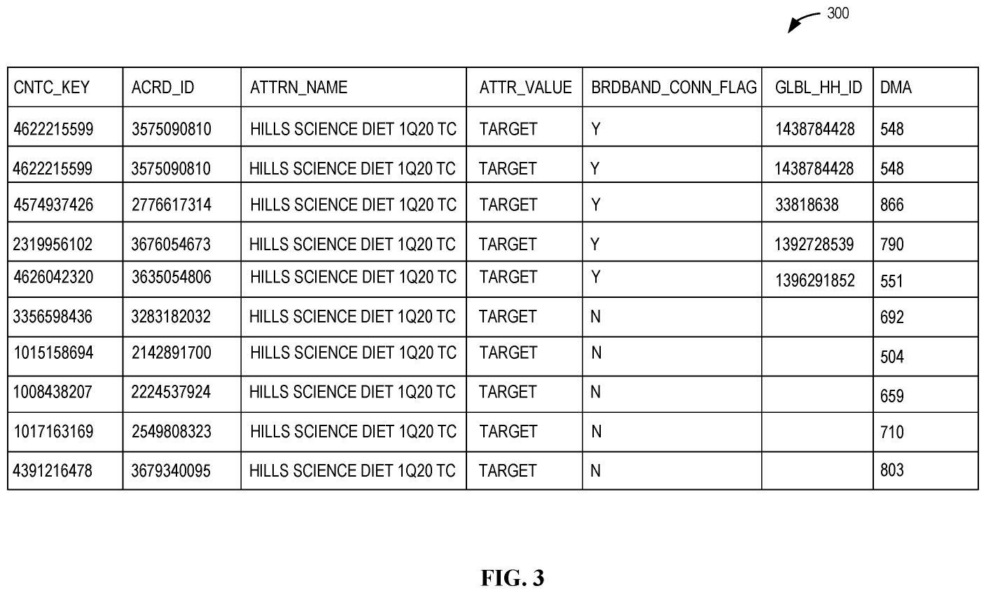

FIG. 3 illustrates an example table 300 representative of an input addressable target file data. The example table 300 illustrates an example addressable target file obtained by the example addressable ad data collector circuitry 132 of FIG. 1. In examples disclosed herein, the addressable target file identifies which RPD or ACR devices were served an addressable advertisement, and when those devices were served the addressable advertisement. In examples disclosed herein, the addressable target file also contains observations for when an addressable advertisement was served to a non-RPD/non-ACR device, in addition to the RPD/ACR instances. In the example table 300, each RPD and ACR capable household (HH) is assigned a global household identifier (e.g., GLBL_HH_ID). In some examples, the households included in the addressable target file are attached to a DMA based on the identifier data “CNTC KEY” and “ACRD ID” of table 300.

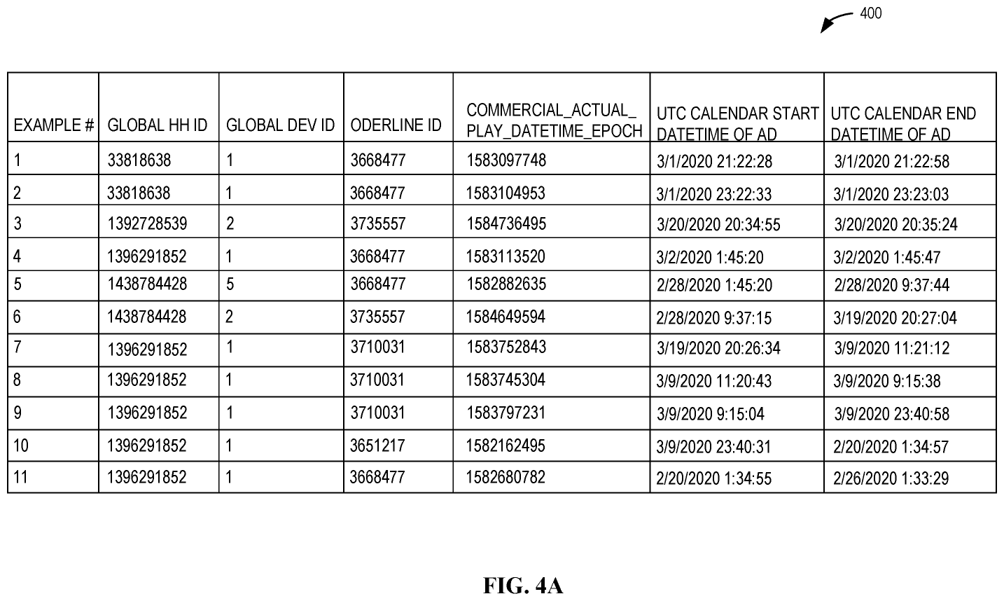

FIGS. 4A and 4B illustrate example tables 400, 405 including return path data (RPD) addressable advertisements from the input addressable target file data included in the example table 300 of FIG. 3. In the illustrated example of FIG. 4A, the example table 400 includes the identifier information (e.g., “Global HH ID,” “Global Dev ID,” and “Order Line ID”) of RPD addressable advertisements in the addressable target file data. The example table 405 of FIG. 4B includes corresponding viewing mode data (e.g., “1” for live and “2” for time-shifted, such as via a DVR) and DMA identifiers to the data illustrated in the example table 400 of FIG. 4A. In the illustrated examples, the addressable impressions determiner circuitry 204 of FIG. 2 uses the RPD addressable advertisements data in tables 400 and 405 in the calculations to determine addressable advertisement impressions for non-RPD/non-ACR capable households, as described above in connection with FIG. 2.

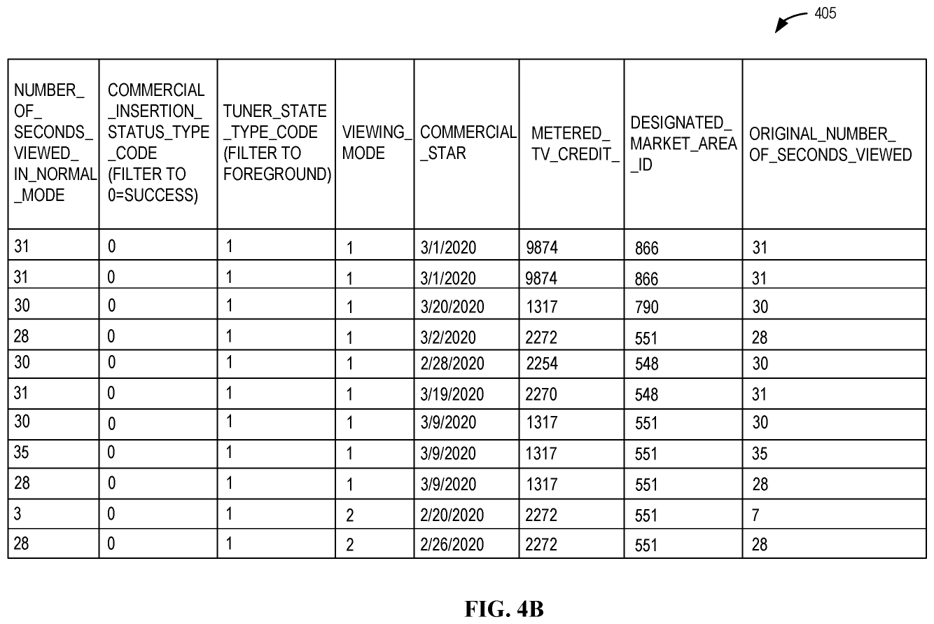

FIG. 5 illustrates an example table 500 including input tuning data from households. In the example table 500, households (HH) that did not receive the addressable advertisements are removed from the input data applied to the example addressable impressions determiner circuitry 204. The example table 500 illustrates example tuning data for the addressable advertisements that is used by the example addressable impressions determiner circuitry 204 to determine the addressable advertisement impressions for non-RPD/non-ACR capable households.

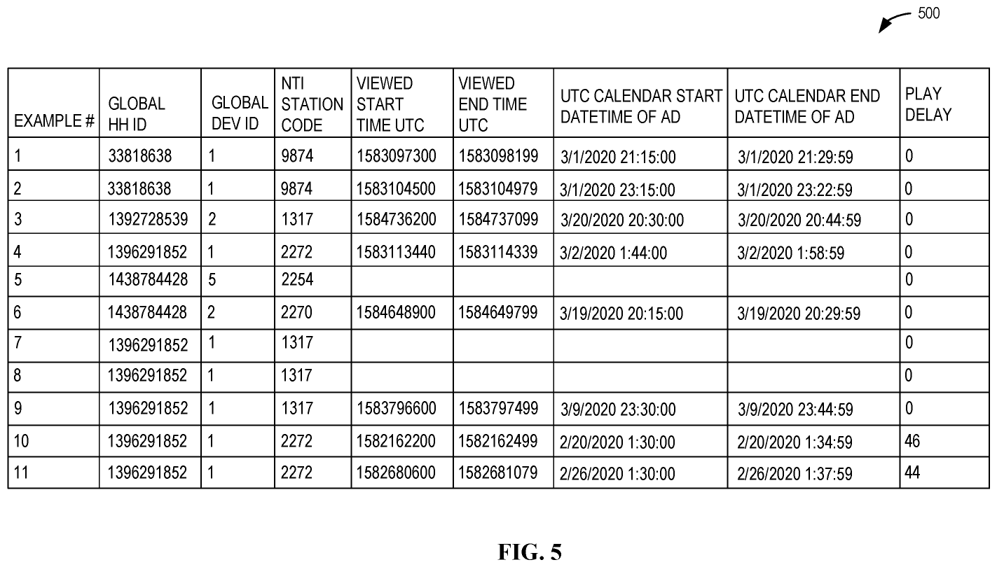

FIG. 6 illustrates an example table 600 including identifying household identifiers for assigning designated market area (DMA) to non-RPD data. In the illustrated example, table 600 includes household identifiers (e.g., “CNTC KEY” and “ACRD ID”) that are used to match with DMAs for assigning to the non-RPD and non-ACR data.

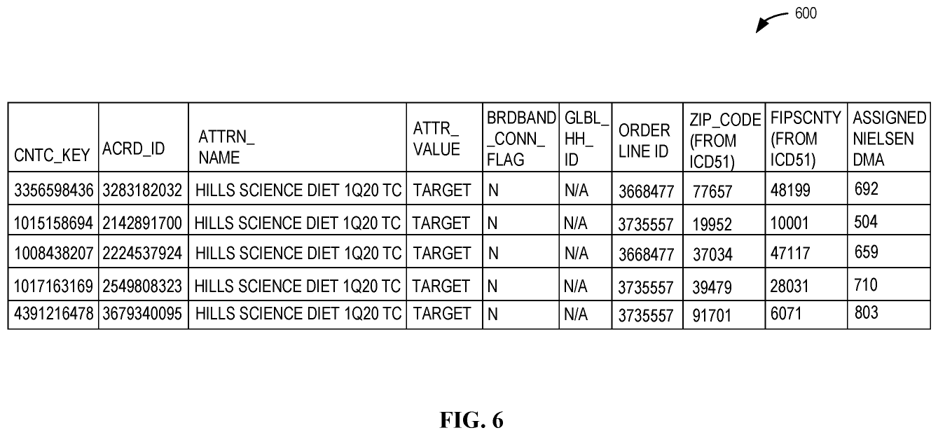

FIG. 7 illustrates an example table 700 including assigning DMA households from reference zip code data. The example table 700 includes codes (e.g., zip codes, fipscntry code, etc.) that are stored in a reference file for looking up the DMA corresponding to the households (HHs).

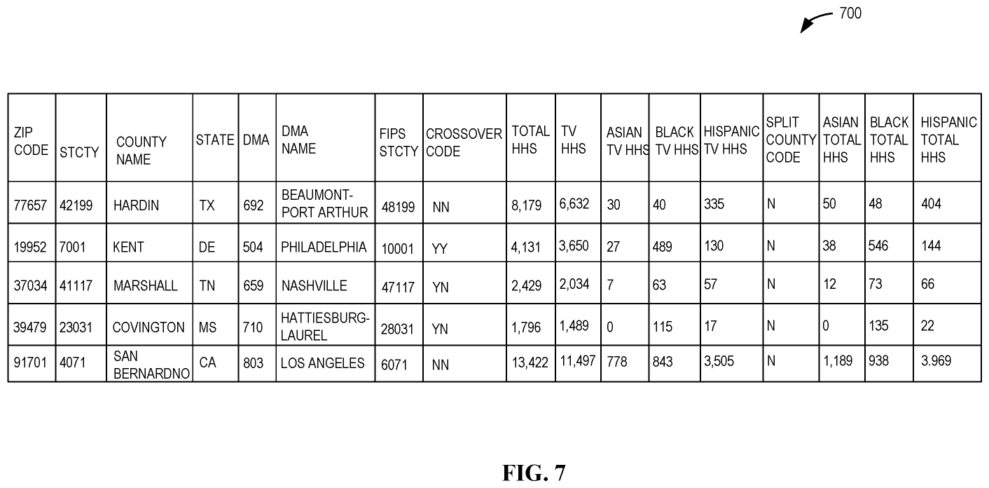

FIGS. 8A and 8B illustrate example tables 800, 805 of impressions data for log level households and log level persons 2+. In the illustrated example, table 800 of FIG. 8A includes example log level household impressions data obtained by the example database interface 202. The example table 805 of FIG. 8B includes example log level persons 2+ impressions data obtained by the example database interface 202.

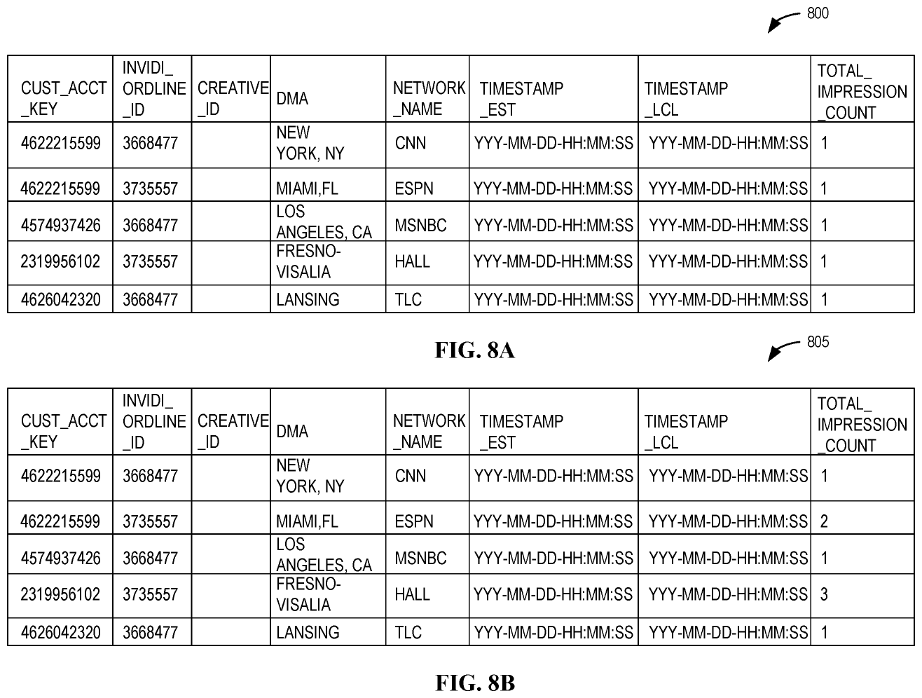

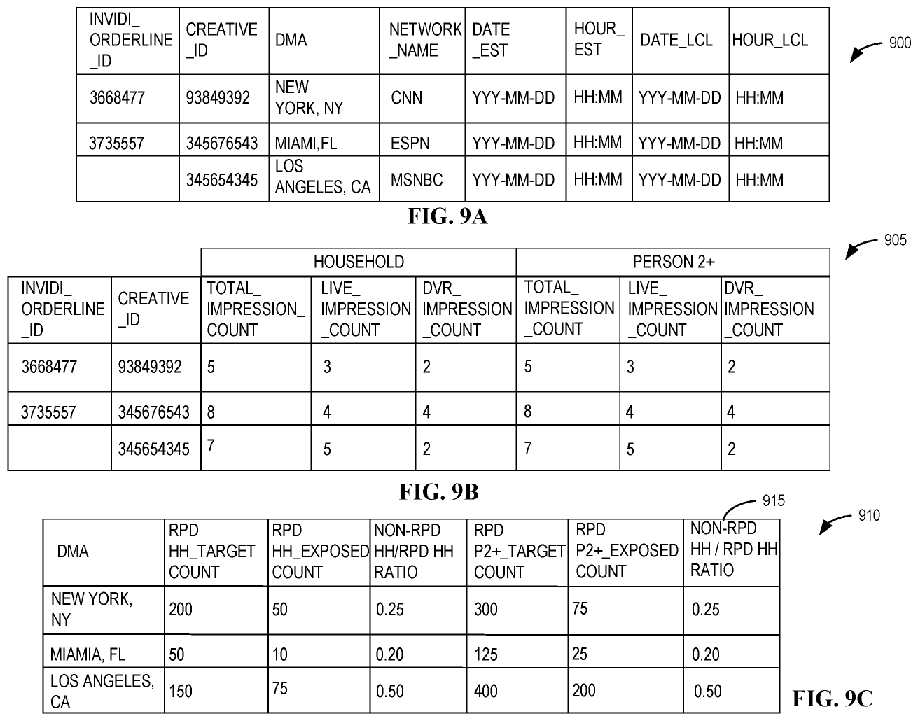

FIGS. 9A and 9B illustrate example tables 900, 905 of the combined impressions data from the log level household impressions and log level persons 2+ impressions. The examples tables 900 and 905 illustrate the combined/sum of the impressions data for households and persons 2+ illustrated in tables 800 and 805 of FIGS. 8A and 8B. In the example tables 900 and 905, the impressions data is separated into categories of “live” and “DVR” (or, more generally, time-shifted) by the example database interface 202 of FIG. 2.

FIG. 9C illustrates an example table 910 of calculated non-PRD/RPD ratio data based on the impressions data. In the illustrated example, table 910 includes example ratios 915 of non-RPD/non-ACR impressions to RPD/ACR impressions based on the impressions data included in the example tables 900 and 905. In some examples, the ratios 915 are the impressions adjustment ratios determined by the example addressable impressions determiner circuitry 204. In the illustrated examples, the addressable impressions determiner circuitry 204 determines the impressions adjustment ratios (e.g., the ratios 915) based on the impressions data obtained by the database interface 202 (tables 900 and 905) of the served vs. exposed households in the RPD/ACR capable footprint using the example Equation 1, as described above in connection with FIG. 2. For example, in table 910 of FIG. 9C, the exposed RPD household count (e.g., 50) is divided by the target/served RPD household count (e.g., 200) to determine an impressions adjustment ratio of 0.25. In some examples, the addressable impressions determiner circuitry 204 calculates the ratios 915 by designated market areas (DMAs).

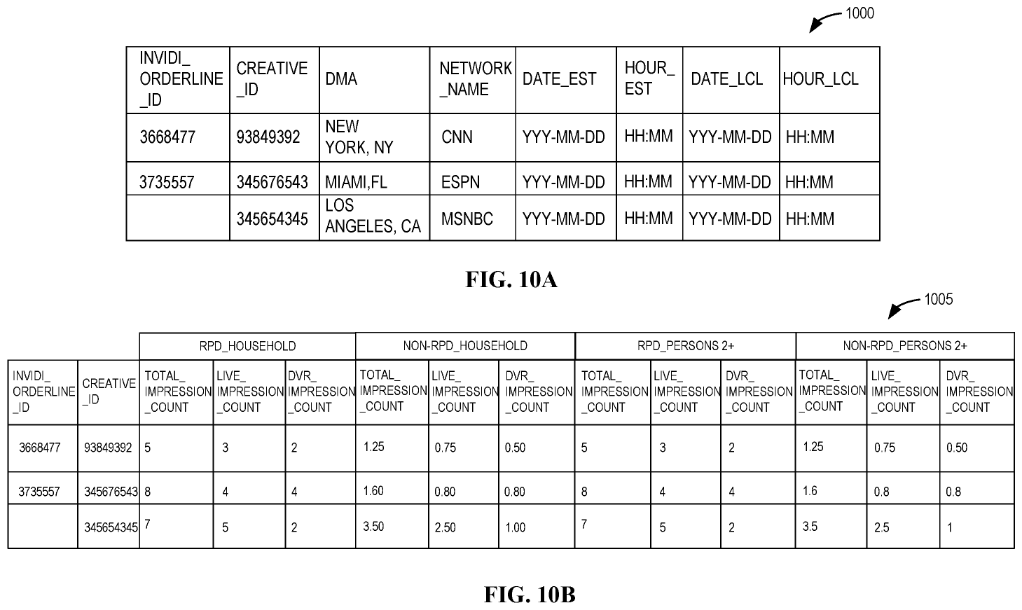

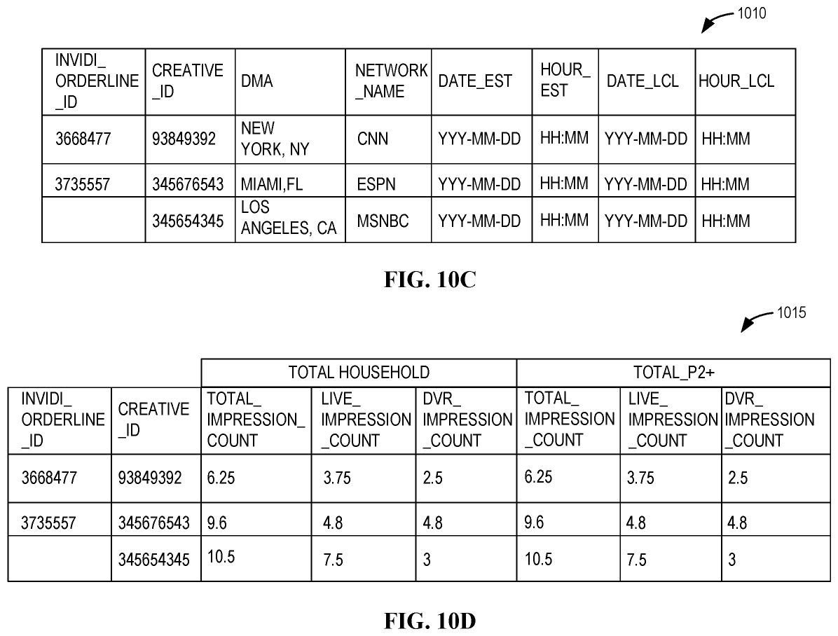

FIGS. 10A and 10B illustrate example tables 1000, 1005 of applying the ratio data (e.g., the ratios 915) of FIG. 9C to the aggregated impressions data (e.g., in tables 900 and 905 of FIGS. 9A and 9B). In some examples, addressable impressions determiner circuitry 204 applies the ratio data (e.g., the ratios 915) to the aggregated impressions at the DMA/day/hour/live/TIME-SHIFTED levels for the household level and person 2+ level. In the illustrated examples, the addressable impressions determiner circuitry 204 multiplies the RPD/ACR impressions of the aggregated impressions data by the ratio data (e.g., the ratios 915) to determine the non-RPD/non-ACR impressions, as illustrated in the example tables 1000 and 1005. For example, a total RPD household impression count of 5 in table 1005 of FIG. 10B, the example addressable impressions determiner circuitry 204 multiplies 5 by the corresponding ratio 915 of FIG. 9C (e.g., 0.25) to determine the total non-RPD household impression count of 1.25.

FIGS. 10C and 10D illustrate example tables 1010, 1015 of determining total campaign impressions from the RPD/ACR and non-RPD/non-ACR impressions. In the illustrated examples, the example addressable impressions determiner circuitry 204 combines/sums the RPD/ACR impressions and the non-RPD/non-ACR impressions data to determine to total campaign impressions for the addressable advertisement. For example, the total impressions count for RPD households in table 1005 of FIG. 10B (e.g., 5) is summed/combined with the total impressions count for non-RPD households in table 1005 (e.g., 1.25) to determine the total impressions count for total households (e.g., 6.25) in the example table 1015 of FIG. 10D. The example tables 1010 and 1015 of FIGS. 10C and 10D illustrate example total campaign impressions for the household level and persons 2+ level.

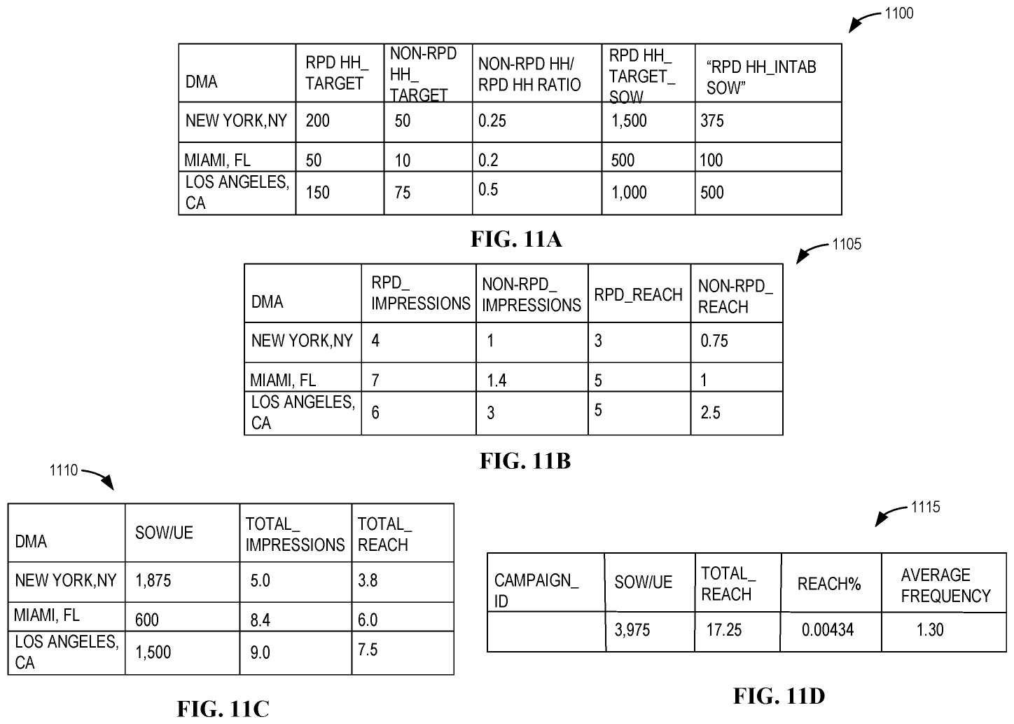

FIGS. 11A-11D illustrate example tables 1100, 1105, 1110, and 1115 of calculating reach and frequency measurements. In the illustrated example of FIG. 11A, the example table 1100 includes SOW metrics for RPD/ACR households for intab households and for target households. In the illustrated examples, the example reach and frequency calculator circuitry 206 of FIG. 2 uses the SOW metrics for RPD/ACR households for intab households and for target households included in the example table 1100 to calculate an intab household ratio, as described above in connection with the example Equation 2. In some examples, the reach and frequency calculator circuitry 206 determines the intab households ratio by using the data included in the example table 1100 (e.g., by dividing the sum of the SOW metrics of all RPD/ACR intab households of the campaign and the weights for non-RPD/non-ACR intab households by the sum of the SOW metrics of all RPD intab households of the target households and weights of non-RPD/non-ACR intab households). For example, the reach and frequency calculator circuitry 206 divides the RPD HH_intab SOW (e.g., 375) by the RPD HH_target SOW (e.g., 1500) to determine the intab households ratio (e.g. 0.25). In some examples, the reach and frequency calculator circuitry 206 applies the intab households ratio to the non-RPD/non-ACR target SOW metrics.

In the illustrated example of FIG. 11B, the example table 1105 illustrates calculated non-RPD/non-ACR impressions and calculated non-RPD/non-ACR reaches. In some examples, the reach and frequency calculator circuitry 206 calculates non-RPD/non-ACR reach by applying the ratio of intab households determined in the example table 1100 to the RPD reach measurements (e.g., RPD_Reach). The example reach and frequency calculator circuitry 206 determines a non-RPD/non-ACR reach based on the intab household ratio and the RPD/ACR reach (e.g., number of impressions from unique audience members in the RPD/ACR impressions data). The example reach and frequency calculator circuitry 206 multiplies the intab household ratio and the RPD/ACR reach to determine the non-RPD/non-ACR reach. The example table 1105 illustrates example non-RPD/non-ACR reaches calculated by the example reach and frequency calculator circuitry 206. For example, the reach and frequency calculator circuitry 206 multiplies the RPD reach (e.g., 3) by the corresponding intab households ratio of table 1100 (e.g., 0.25) to determine the non-RPD reach (e.g., 0.75).

In the illustrated example of FIG. 11C, the example table 1110 illustrates example total SOW metrics data determined by the example reach and frequency calculator circuitry 206. For example, the example reach and frequency calculator circuitry 206 sums/combines the determined SOW intab metrics, impressions, and reaches across RPD/ACR households and non-RPD/non-ACR households. In the illustrated example of FIG. 11D, the example table 1115 illustrates the example total percent reach and average frequency measurements determined by the example reach and frequency calculator circuitry 206. In some examples, the reach and frequency calculator circuitry 206 determines the reach percentage using the example Equation 3, as described above in connection with FIG. 2. For example, the reach and frequency calculator circuitry 206 divides the total reach of table 1115 (e.g., 17.25) (from combining the total reach column of table 1110) by the total SOW metrics of table 1115 (e.g., 3975) (from combining the total SOW column of table 1110) and multiplies the result by 100 to get the percent reach (e.g., 0.00434). In some examples, the reach and frequency calculator circuitry 206 determines the average frequency using the example Equation 4, as described above in connection with FIG. 2. For example, the reach and frequency calculator circuitry 206 divides the total impressions from table 1105 (e.g., 22.4) (from combining the RPD impressions and non-RPD impressions columns of table 1110) by the total reach of table 1115 (e.g., 17.25) to get the average frequency (e.g., 1.3). The example table 1115 illustrates example metrics for percent reach and average frequency according to the teachings of this disclosure. In the illustrated example of table 1115, the percent reach is expressed as a percentage, and the average frequency is expressed as a decimal.

While an example manner of implementing the example non-return path adjuster circuitry 138 of FIG. 1 is illustrated in FIG. 2, one or more of the elements, processes, and/or devices illustrated in FIG. 2 may be combined, divided, re-arranged, omitted, eliminated, and/or implemented in any other way. Further, the example database interface 202, the example addressable impressions determiner circuitry 204, the example reach and frequency calculator circuitry 206, and/or, more generally, the example non-return path adjuster circuitry 138 of FIG. 1, may be implemented by hardware alone or by hardware in combination with software and/or firmware. Thus, for example, any of the example database interface 202, the example addressable impressions determiner circuitry 204, the example reach and frequency calculator circuitry 206, and/or, more generally, the example non-return path adjuster circuitry 138, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example non-return path adjuster circuitry 138 of FIG. 1 may include one or more elements, processes, and/or devices in addition to, or instead of, those illustrated in FIG. 2, and/or may include more than one of any or all of the illustrated elements, processes and devices.

A flowchart representative of example hardware logic circuitry, machine readable instructions, hardware implemented state machines, and/or any combination thereof for implementing the non-return path adjuster circuitry 138 of FIG. 2 is shown in FIG. 12. The machine readable instructions may be one or more executable programs or portion(s) of an executable program for execution by processor circuitry, such as the processor circuitry 1312 shown in the example processor platform 1300 discussed below in connection with FIG. 13 and/or the example processor circuitry discussed below in connection with FIGS. 14 and/or 15. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 12, many other methods of implementing the example non-return path adjuster circuitry 138 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 12 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 12 is a flowchart representative of example machine readable instructions and/or example operations 1200 that may be executed and/or instantiated by processor circuitry to implement the example non-return path adjuster circuitry 138 of FIGS. 1 and/or 2. The machine readable instructions and/or the operations 1200 of FIG. 12 begin at block 1202, at which the example database interface 202 obtains the impressions data. The example database interface 202 obtains log level household impressions and log level persons 2+ impressions for addressable advertisements for RPD/ACR devices included in the panel data, return path data, Smart TV data, and reference advertisement data (e.g., the addressable target file) from the example panel database 122, the example RPD database 126, the example Smart TV database 130, and the example addressable ad database 134, respectively. The database interface 202 analyzes the panel data, return path data, the Smart TV data, and the reference advertisement data by identifying data associated with addressable advertisements exposure associated with RPD/ACR media devices, removing duplicate data, etc. At block 1204, the example database interface 202 combines the impressions data. At block 1206, the example database interface 202 separates the combined impressions data into live impressions and DVR impressions.

At block 1208, the example addressable impressions determiner circuitry 204 determines the non-RPD/non-ACR addressable advertisement impressions. The example addressable impressions determiner circuitry 204 determines the non-RPD/non-ACR addressable advertisement impressions from the impressions data identified by the example database interface 202 for RPD/ACR devices/households. In some examples, the addressable impressions determiner circuitry 204 calculates an impressions adjustment ratio to determine the non-RPD/non-ACR impressions (e.g., impressions associated with non-RPD and/or non-ACR devices). In some examples, the addressable impressions determiner circuitry 204 calculates the impressions adjustment ratio using the RPD/ACR impressions (e.g., impressions associated with RPD and/or ACR media devices) determined by the example audience metrics calculator circuitry 136 of FIG. 1. In some examples, the addressable impressions determiner circuitry 204 calculates the impressions adjustment ratio by designated market areas (DMAs) for Persons 2+ and households level impressions. The example addressable impressions determiner circuitry 204 calculates the impressions adjustment ratio based on the served vs. exposed households in the RPD/ACR capable footprint. For example, the addressable impressions determiner circuitry 204 calculates the impression adjustment ratio using the Equation 1 described above in connection with FIG. 2. The—43−stimate addressable impressions determiner circuitry 204 determines the non-RPD/non-ACR addressable advertisement impressions by applying the calculated impressions adjustment ratio to the aggregated RPD/ACR addressable advertisement impressions. For example, the addressable impressions determiner circuitry 204 multiplies the aggregated RPD/ACR impressions by the impressions adjustment ratio to determine the non-RPD/non-ACR addressable advertisement impressions. For example, if 45% of the target households in the RPD/ACR capable footprint are exposed to the addressable advertisement (e.g., the calculated impressions adjustment ratio is 0.45 or 45%), the example addressable impressions determiner circuitry 204 determines that 45% of the target households in the non-RPD/non-ACR capable footprint are also exposed. However, the example addressable impressions determiner circuitry 204 may use other calculations to determine the non-RPD/non-ACR addressable advertisement impression. In some examples, addressable impressions determiner circuitry 204 applies the calculated impressions adjustment ratio to the aggregated RPD/ACR addressable advertisement impressions at the DMA/day/hour/live/TIME-SHIFTED (e.g., DVR) levels (e.g., RPD/ACR addressable advertisement impressions segmented into groups based on DMA, day, hour, live, time-shifted, etc.) for households and persons 2+ log levels.

At block 1210, the example addressable impressions determiner circuitry 204 determines the total campaign impressions based on the combination of RPD/ACR addressable advertisement impressions and non-RPD/ACR addressable advertisement impressions. The example addressable impressions determiner circuitry 204 sums/combines the measured RPD/ACR impressions and the estimated non-RPD/non-ACR impressions to determine the total addressable advertisement impressions.

At block 1212, the example reach and frequency calculator circuitry 206 calculates the reach and frequency. The example reach and frequency calculator circuitry 206 calculates the reach and frequency based on the RPD/ACR impressions, the determined non-RPD/ACR impressions, and impressions adjustment ratio. In some examples, the reach and frequency calculator circuitry 206 uses sum of weight (SOW) metrics for RPD/ACR households for intab households (e.g., supplying usable data) and for target households. In examples disclosed herein, SOW metrics estimate the number of individuals in the demographic break and geography area. In such examples, the reach and frequency calculator circuitry 206 calculate the reach for addressable advertisements while accounting for non-RPD/non-ACR devices using the SOW metrics for RPD/ACR households for intab households and for target households. In some examples, the example reach and frequency calculator circuitry 206 calculates an intab household ratio of RPD/ACR households. For example, the example reach and frequency calculator circuitry 206 may calculate the intab household ratio using the example Equation 2 described above in connection with FIG. 2. In some examples, the reach and frequency calculator circuitry 206 applies (e.g., multiplies) the calculated intab household ratio to the SOW metrics for the non-RPD/non-ACR target households included in the addressable target file to determine the SOW metrics for the non-RPD/non-ACR intab households. The example reach and frequency calculator circuitry 206 determines a non-RPD/non-ACR reach based on the intab household ratio and the RPD/ACR reach (e.g., number of impressions from unique audience members in the RPD/ACR impressions data). The example reach and frequency calculator circuitry 206 multiplies the intab household ratio and the RPD/ACR reach to determine the non-RPD/non-ACR reach. In some examples, the example reach and frequency calculator circuitry 206 sums/combines the determined SOW intab metrics, impressions, and reaches across RPD/ACR households and non-RPD/non-ACR households.

The example reach and frequency calculator circuitry 206 determines the reach percentage using the example Equation 3 described above in connection with FIG. 2. In some examples, the example reach and frequency calculator circuitry 206 divides the total teach across RPD/ACR and non-RPD/non-ACR households by the total SOW intab metrics data for RPD/ACR intab households and non-RPD/non-ACR intab households to determine the reach percentage. In some examples, the example reach and frequency calculator circuitry 206 determines the average frequency using the example Equation 4 described above in connection with FIG. 2. In some examples, the example reach and frequency calculator circuitry 206 divides the total impressions (RPD/ACR and non-RPD/non-ACR) by the total reach across RPD/ACR and non-RPD/non-ACR households to determine the average frequency. After block 1212, program 1200 ends.

FIG. 13 is a block diagram of an example processor platform 1300 structured to execute and/or instantiate the machine readable instructions and/or the operations of FIG. 12 to implement the example non-return path adjuster circuitry 138 of FIGS. 1 and/or 2. The processor platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1300 of the illustrated example includes processor circuitry 1312. The processor circuitry 1312 of the illustrated example is hardware. For example, the processor circuitry 1312 can be implemented by one or more integrated circuits, logic circuits, FPGAs, microprocessors, CPUs, GPUs, DSPs, and/or microcontrollers from any desired family or manufacturer. The processor circuitry 1312 may be implemented by one or more semiconductor based (e.g., silicon based) devices. In this example, the processor circuitry 1312 implements the example database interface 202, the example addressable impressions determiner circuitry 204, and the example reach and frequency calculator circuitry 206.

The processor circuitry 1312 of the illustrated example includes a local memory 1313 (e.g., a cache, registers, etc.). The processor circuitry 1312 of the illustrated example is in communication with a main memory including a volatile memory 1314 and a non-volatile memory 1316 by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317.

The processor platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user to enter data and/or commands into the processor circuitry 1312. The input device(s) 1322 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1300 of the illustrated example also includes one or more mass storage devices 1328 to store software and/or data. Examples of such mass storage devices 1328 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 1332, which may be implemented by the machine readable instructions of FIG. 12, may be stored in the mass storage device 1328, in the volatile memory 1314, in the non-volatile memory 1316, and/or on a removable non-transitory computer readable storage medium such as a CD or DVD.

FIG. 14 is a block diagram of an example implementation of the processor circuitry 1312 of FIG. 13. In this example, the processor circuitry 1312 of FIG. 13 is implemented by a general purpose microprocessor 1400. The general purpose microprocessor circuitry 1400 executes some or all of the machine readable instructions of the flowchart of FIG. 12 to effectively instantiate the circuitry of FIG. 2 as logic circuits to perform the operations corresponding to those machine readable instructions. Iia some such examples, the circuitry of FIG. 2 is instantiated by the hardware circuits of the microprocessor 1400 in combination—with the instructions. For example, the microprocessor 1400 may implement multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine readable instructions and/or operations represented by the flowchart of FIG. 12.

The cores 1402 may communicate by a first example bus 1404. In some examples, the first bus 1404 may implement a communication bus to effectuate communication associated with one(s) of the cores 1402. For example, the first bus 1404 may implement at least one of an Inter-Integrated Circuit (I2C) bus, a Serial Peripheral Interface (SPI) bus, a PCI bus, or a PCIe bus. Additionally or alternatively, the first bus 1404 may implement any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2_ cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1314, 1316 of FIG. 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the L1 cache 1420, and a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer based operations. In other examples, the AL circuitry 1416 also performs floating point operations. In yet other examples, the AL circuitry 1416 may include first AL circuitry that performs integer based operations and second AL circuitry that performs floating point operations. In some examples, the AL circuitry 1416 may be referred to as an Arithmetic Logic Unit (ALU). The registers 1418 are semiconductor-based structures to store data and/or instructions such as results of one or more of the operations performed by the AL circuitry 1416 of the corresponding core 1402. For example, the registers 1418 may include vector register(s), SIMD register(s), general purpose register(s), flag register(s), segment register(s), machine specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure including distributed throughout the core 1402 to shorten access time. The second bus 1422 may implement at least one of an I2C bus, a SPI bus, a PCI bus, or a PCIe bus

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (Ics) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 15 is a block diagram of another example implementation of the processor circuitry 1312 of FIG. 13. In this example, the processor circuitry 1312 is implemented by FPGA circuitry 1500. The FPGA circuitry 1500 can be used, for example, to perform operations that could otherwise be performed by the example microprocessor 1400 of FIG. 14 executing corresponding machine readable instructions. However, once configured, the FPGA circuitry 1500 instantiates the machine readable instructions in hardware and, thus, can often execute the operations faster than they could be performed by a general purpose microprocessor executing the corresponding software.

More specifically, in contrast to the microprocessor 1400 of FIG. 14 described above (which is a general purpose device that may be programmed to execute some or all of the machine readable instructions represented by the flowchart of FIG. 12 but whose interconnections and logic circuitry are fixed once fabricated), the FPGA circuitry 1500 of the example of FIG. 15 includes interconnections and logic circuitry that may be configured and/or interconnected in different ways after fabrication to instantiate, for example, some or all of the machine readable instructions represented by the flowchart of FIG. 12. In particular, the FPGA 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the software represented by the flowchart of FIG. 12. As such, the FPGA circuitry 1500 may be structured to effectively instantiate some or all of the machine readable instructions of the flowchart of FIG. 12 as dedicated logic circuits to perform the operations corresponding to those software instructions in a dedicated manner analogous to an ASIC. Therefore, the FPGA circuitry 1500 may perform the operations corresponding to the some or all of the machine readable instructions of FIG. 12 faster than the general purpose microprocessor can execute the same.

In the example of FIG. 15, the FPGA circuitry 1500 is structured to be programmed (and/or reprogrammed one or more times) by an end user by a hardware description language (HDL) such as Verilog. The FPGA circuitry 1500 of FIG. 15, includes example input/output (I/O) circuitry 1502 to obtain and/or output data to/from example configuration circuitry 1504 and/or external hardware (e.g., external hardware circuitry) 1506. For example, the configuration circuitry 1504 may implement interface circuitry that may obtain machine readable instructions to configure the FPGA circuitry 1500, or portion(s) thereof. In some such examples, the configuration circuitry 1504 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1506 may implement the microprocessor 1400 of FIG. 14. The FPGA circuitry 1500 also includes an array of example logic gate circuitry 1508, a plurality of example configurable interconnections 1510, and example storage circuitry 1512. The logic gate circuitry 1508 and interconnections 1510 are configurable to instantiate one or more operations that may correspond to at least some of the machine readable instructions of FIG. 12 and/or other desired operations. The logic gate circuitry 1508 shown in FIG. 15 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations. The logic gate circuitry 1508 may include other electrical structures such as look-up tables (LUTs), registers (e.g., flip-flops or latches), multiplexers, etc.

The interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example Dedicated Operations Circuitry 1514. In this example, the Dedicated Operations Circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the processor circuitry 1312 of FIG. 13, many other approaches are contemplated. For example, as mentioned above, modern FPGA circuitry may include an on-board CPU, such as one or more of the example CPU 1520 of FIG. 15. Therefore, the processor circuitry 1312 of FIG. 13 may additionally be implemented by combining the example microprocessor 1400 of FIG. 14 and the example FPGA circuitry 1500 of FIG. 15. In some such hybrid examples, a first portion of the machine readable instructions represented by the flowchart of FIG. 12 may be executed by one or more of the cores 1402 of FIG. 14, a second portion of the machine readable instructions represented by the flowchart of FIG. 12 may be executed by the FPGA circuitry 1500 of FIG. 15, and/or a third portion of the machine readable instructions represented by the flowchart of FIG. 12 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 1312 of FIG. 13 may be in one or more packages. For example, the processor circuitry 1400 of FIG. 14 and/or the FPGA circuitry 1500 of FIG. 15 may be in one or more packages. In some examples, an XPU may be implemented by the processor circuitry 1312 of FIG. 13, which may be in one or more packages. For example, the XPU may include a CPU in one package, a DSP in another package, a GPU in yet another package, and an FPGA in still yet another package.

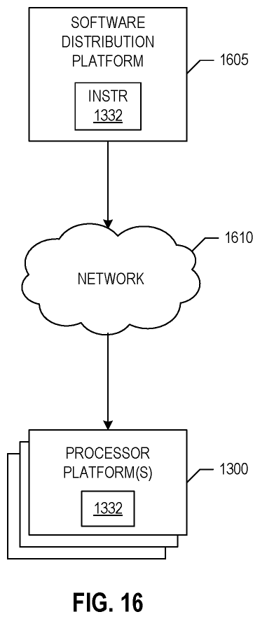

A block diagram illustrating an example software distribution platform 1605 to distribute software such as the example machine readable instructions 1332 of FIG. 13 to hardware devices owned and/or operated by third parties is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine readable instructions 1332 of FIG. 13. The third parties may be consumers, users, retailers, OEMs, etc., who purchase and/or license the software for use and/or re-sale and/or sub-licensing. In the illustrated example, the software distribution platform 1605 includes one or more servers and one or more storage devices. The storage devices store the machine readable instructions 1332, which may correspond to the example machine readable instructions 1200 of FIG. 12, as described above. The one or more servers of the example software distribution platform 1605 are in communication with a network 1610, which may correspond to any one or more of the Internet and/or any of the example network 114 of FIG. 1 and the example network 1326 of FIG. 13 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1332 from the software distribution platform 1605. For example, the software, which may correspond to the example machine readable instructions 1200 of FIG. 12, may be downloaded to the example processor platform 1300, which is to execute the machine readable instructions 1332 to implement the example non-return path adjuster circuitry 138 of FIGS. 1 and/or 2. In some example, one or more servers of the software distribution platform 1605 periodically offer, transmit, and/or force updates to the software (e.g., the example machine readable instructions 1332 of FIG. 13) to ensure improvements, patches, updates, etc., are distributed and applied to the software at the end user devices.

From the foregoing, it will be appreciated that example systems, methods, apparatus, and articles of manufacture have been disclosed for reconciliation of commercial measurement ratings for non-return path data media devices. The disclosed systems, methods, apparatus, and articles of manufacture improve the audience metrics to account for addressable advertisements provided to non-return path data household devices. The disclosed systems, methods, apparatus, and articles of manufacture obtain log level household impressions and log level persons 2+ impressions for non-RPD/non-ACR capable households. The disclosed systems, methods, apparatus, and articles of manufacture calculate a ratio of the non-RPD/non-ACR devices that were served the addressable advertisement to the RPD/ACR devices were served the addressable advertisement by designated market area (DMA) for Persons 2+ and households using the addressable target file. The disclosed systems, methods, apparatus, and articles of manufacture sum the RPD/ACR impressions and the non-RPD/non-ACR impressions to get total addressable advertisement impressions. The disclosed systems, methods, apparatus, and articles of manufacture improve audience metrics data to account for the serving of addressable advertisements to non-RPD/ACR media devices in order to determine the addressable audience measurements and ensure the addressable audience estimates are not understated.

Example methods, apparatus, systems, and articles of manufacture for reconciliation of commercial measurement ratings for non-return path data media devices are disclosed herein. Further examples and combinations thereof include the following:

Example 1 includes an apparatus comprising at least one memory, instructions, and processor circuitry to execute the instructions to estimate unreported addressable impressions for a plurality of unreported households for an addressable advertisement based on an impressions adjustment ratio of served reportable addressable impressions to exposed reported addressable impressions included in impressions data associated with reported households, and calculate at least one of reach or frequency for the addressable advertisement to account for non-reporting devices, the at least one of the reach or the frequency determined based on the exposed reported addressable impressions, the estimated unreported addressable impressions, and the impressions adjustment ratio.

Example 2 includes the apparatus of example 1, wherein the processor circuitry is to obtain the impressions data, the impressions data including panel data collected from media devices, return path data collected from service providers, Smart TV data collected from smart television devices, and reference advertisement data from an advertisement provider.

Example 3 includes the apparatus of example 2, wherein the reference advertisement data identifies which reported households and which unreported households were served the addressable advertisement.

Example 4 includes the apparatus of example 2, wherein the processor circuitry is to estimate the unreported addressable impressions by applying the impressions adjustment ratio to the exposed reported addressable impressions included in the impressions data.

Example 5 includes the apparatus of example 1, wherein the processor circuitry is to determine total campaign impressions for the addressable advertisement by determining a sum of the exposed reported addressable impressions and the estimated unreported addressable impressions.

Example 6 includes the apparatus of example 1, wherein the processor circuitry is to calculate a total reach by determining a sum of a first reach across the reported households and a second reach across the unreported households.

Example 7 includes the apparatus of example 6, wherein the processor circuitry is to calculate the reach for the addressable advertisement by dividing the total reach by total sum of weight (SOW) metrics data for the reported households and unreported households and multiplying by one hundred.

Example 8 includes the apparatus of example 6, wherein the processor circuitry is to calculate the frequency for the addressable advertisement by dividing a sum of total impressions for the reported households and the unreported households by the total reach.

Example 9 includes the apparatus of example 1, wherein the processor circuitry is to determine ratings data for the addressable advertisement based on the at least one of the reach or the frequency, the processor circuitry to report the ratings data to an advertisement provider of the addressable advertisement to adjust addressable advertisements provided to the unreported households and the reported households.

Example 10 includes At least one non-transitory computer readable medium comprising instructions which, when executed, cause one or more processors to at least estimate unreported addressable impressions for a plurality of unreported households for an addressable advertisement based on an impressions adjustment ratio of served reportable addressable impressions to exposed reported addressable impressions included in impressions data associated with reported households, and calculate at least one of reach or frequency for the addressable advertisement to account for non-reporting devices, the at least one of the reach or the frequency determined based on the exposed reported addressable impressions, the estimated unreported addressable impressions, and the impressions adjustment ratio.

Example 11 includes the at least one non-transitory computer readable medium of example 10, wherein the instructions are to cause the one or more processors to obtain the impressions data, the impressions data including panel data collected from media devices, return path data collected from service providers, Smart TV data collected from smart television devices, and reference advertisement data from an advertisement provider.

Example 12 includes the at least one non-transitory computer readable medium of example 11, wherein the reference advertisement data identifies which reported households and which unreported households were served the addressable advertisement.

Example 13 includes the at least one non-transitory computer readable medium of example 11, wherein the instructions are to cause the one or more processors to estimate the unreported addressable impressions by applying the impressions adjustment ratio to the exposed reported addressable impressions included in the impressions data.

Example 14 includes the at least one non-transitory computer readable medium of example 10, wherein the instructions are to cause the one or more processors to determine total campaign impressions for the addressable advertisement by determining a sum of the exposed reported addressable impressions and the estimated unreported addressable impressions.

Example 15 includes the at least one non-transitory computer readable medium of example 10, wherein the instructions are to cause the one or more processors to calculate a total reach by determining a sum of a first reach across the reported households and a second reach across the unreported households.

Example 16 includes the at least one non-transitory computer readable medium of example 15, wherein the instructions are to cause the one or more processors to calculate the reach for the addressable advertisement by dividing the total reach by total sum of weight (SOW) metrics data for the reported households and unreported households and multiplying by one hundred.

Example 17 includes the at least one non-transitory computer readable medium of example 15, wherein the instructions are to cause the one or more processors to calculate the frequency for the addressable advertisement by dividing a sum of total impressions for the reported households and the unreported households by the total reach.

Example 18 includes the at least one non-transitory computer readable medium of example 10, wherein the instructions are to cause the one or more processors to determine ratings data for the addressable advertisement based on the at least one of the reach or the frequency, the one or more processors to report the ratings data to an advertisement provider of the addressable advertisement to adjust addressable advertisements provided to the unreported households and the reported households.

Example 19 includes a method comprising estimating unreported addressable impressions for a plurality of unreported households for an addressable advertisement based on an impressions adjustment ratio of served reportable addressable impressions to exposed reported addressable impressions included in impressions data associated with reported households, and calculating at least one of reach or frequency for the addressable advertisement to account for non-reporting devices, the at least one of the reach or the frequency determined using the exposed reported addressable impressions, the estimated unreported addressable impressions, and the impressions adjustment ratio.

Example 20 includes the method of example 19, further including obtaining the impressions data, the impressions data including panel data collected from media devices, return path data collected from service providers, Smart TV data collected from smart television devices, and reference advertisement data from an advertisement provider.

Example 21 includes the method of example 20, wherein the reference advertisement data identifies which reported households and which unreported households were served the addressable advertisement.

Example 22 includes the method of example 20, further including estimating the unreported addressable impressions by applying the impressions adjustment ratio to the exposed reported addressable impressions included in the impressions data.

Example 23 includes the method of example 19, further including determining total campaign impressions for the addressable advertisement by determining a sum of the exposed reported addressable impressions and the estimated unreported addressable impressions.

Example 24 includes the method of example 19, further including calculating a total reach by determining a sum of a first reach across the reported households and a second reach across the unreported households.

Example 25 includes the method of example 24, further including calculating the reach for the addressable advertisement by dividing the total reach by total sum of weight (SOW) metrics data for the reported households and unreported households and multiplying by one hundred.

Example 26 includes the method of example 24, further including calculating the frequency for the addressable advertisement by dividing a sum of total impressions for the reported households and the unreported households by the total reach.

Example 27 includes the method of example 19, further including determining ratings data for the addressable advertisement based on the at least one of the reach or the frequency, and reporting the ratings data to an advertisement provider of the addressable advertisement to adjust addressable advertisements provided to the unreported households and the reported households.

Example 28 includes an apparatus comprising addressable impressions determiner circuitry to estimated addressable impressions for a plurality of first devices for an addressable advertisement based on an impressions adjustment ratio of served addressable impressions to exposed addressable impressions included in impressions data from second devices, wherein the first devices do not support at least one of return path data (RPD) or automatic content recognition (ACR) and the second devices support at least one of the RPD or the ACR, and reach and frequency calculator circuitry to calculate at least one of reach or frequency for the addressable advertisement to account for the first devices, the at least one of the reach or the frequency determined based on the exposed addressable impressions from second devices, the estimated addressable impressions for the first devices, and the impressions adjustment ratio.

Example 29 includes the apparatus of example 28, further including a database interface to obtain the impressions data, the impressions data including panel data collected from media devices, return path data collected from service providers, Smart TV data collected from smart television devices, and reference advertisement data from an advertisement provider.

Example 30 includes the apparatus of example 29, wherein the reference advertisement data identifies which of the second devices and which of the first devices were served the addressable advertisement.

Example 31 includes the apparatus of example 29, wherein the addressable impressions determiner circuitry is to estimate the addressable impressions for the first devices by applying the impressions adjustment ratio to the exposed addressable impressions included in the impressions data from the second devices.

Example 32 includes the apparatus of example 31, wherein the addressable impressions determiner circuitry is to determine total campaign impressions for the addressable advertisement by determining a sum of the exposed addressable impressions and the estimated addressable impressions.

Example 33 includes the apparatus of example 28, wherein the reach and frequency calculator circuitry is to calculate a total reach by determining a sum of a first reach across the second devices and a second reach across the first devices.

Example 34 includes the apparatus of example 33, wherein the reach and frequency calculator circuitry is to calculate the reach for the addressable advertisement by dividing the total reach by total sum of weight (SOW) metrics data for the second devices and the first devices and multiplying by one hundred.

Example 35 includes the apparatus of example 33, wherein the reach and frequency calculator circuitry is to calculate the frequency for the addressable advertisement by dividing a sum of total impressions for the second devices and first devices by the total reach.

Example 36 includes an apparatus comprising means for estimating addressable impressions for a plurality of first devices for an addressable advertisement based on an impressions adjustment ratio of served addressable impressions to exposed addressable impressions included in impressions data from second devices, wherein the first devices do not support at least one of return path data (RPD) or automatic content recognition (ACR) and the second devices support at least one of the RPD or the ACR, and means for calculating at least one of reach or frequency for the addressable advertisement to account for the first devices, the at least one of the reach or the frequency determined based on the exposed addressable impressions from second devices, the estimated addressable impressions for the first devices, and the impressions adjustment ratio.

Example 37 includes the apparatus of example 36, further including means for obtaining the impressions data, the impressions data including panel data collected from media devices, return path data collected from service providers, Smart TV data collected from smart television devices, and reference advertisement data from an advertisement provider.

Example 38 includes the apparatus of example 37, wherein the reference advertisement data identifies which of the second devices and which of the first devices were served the addressable advertisement.

Example 39 includes the apparatus of example 37, wherein the means for estimating is to estimate the addressable impressions by applying the impressions adjustment ratio to the exposed addressable impressions included in the impressions data from the second devices.

Example 40 includes the apparatus of example 39, wherein the means for estimating is to determine total campaign impressions for the addressable advertisement by determining a sum of the exposed addressable impressions and the estimated addressable impressions.

Example 41 includes the apparatus of example 36, wherein the means for calculating is to calculate a total reach by determining a sum of a first reach across the second devices and a second reach across the first devices.

Example 42 includes the apparatus of example 41, wherein the means for calculating is to calculate the reach for the addressable advertisement by dividing the total reach by total sum of weight (SOW) metrics data for the second devices and the first devices and multiplying by one hundred.

Example 43 includes the apparatus of example 41, wherein the means for calculating is to calculate the frequency for the addressable advertisement by dividing a sum of total impressions for the second devices and first devices by the total reach.

Example 44 includes an apparatus comprising interface circuitry, and processor circuitry including one or more of at least one of a central processing unit, a graphic processing unit, or a digital signal processor, the at least one of the central processing unit, the graphic processing unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations, or Application Specific Integrate Circuitry (ASIC) including logic gate circuitry to perform one or more third operations, the processor circuitry to perform at least one of the first operations, the second operations, or the third operations to instantiate addressable impressions determiner circuitry to estimate unreported addressable impressions for a plurality of unreported households for an addressable advertisement based on an impressions adjustment ratio of served reportable addressable impressions to exposed reported addressable impressions included in impressions data from reported households, and reach and frequency calculator circuitry to calculate at least one of reach or frequency for the addressable advertisement to account for non-reporting devices, the at least one of the reach or the frequency determined based on the exposed reported addressable impressions, the estimated unreported addressable impressions, and the impressions adjustment ratio.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. A computing system comprising:
a network interface configured to:
receive monitoring data collected by multiple media meters which monitor media exposure associated with panelist media devices in panel homes recruited by an audience measurement entity,
receive automatic content recognition (ACR) data collected by multiple smart televisions which monitor media exposure in smart television households,
receive return path data (RPD) collected by a media service provider, the RPD including tuning events associated with set-top boxes in RPD households, and
receive reference advertisement data collected by an advertisement provider system for an addressable advertisement, and
a data center comprising a processor and a memory, the data center configured to perform a set of acts comprising:
processing the reference advertisement data to identify served reportable addressable impressions associated with ones of the smart televisions or set-top boxes to which the addressable advertisement was served,
processing the monitoring data, ACR data, and the RPD to identify exposed reported addressable impressions associated with presentation of the addressable advertisement by ones of the panelist media devices, smart televisions, or set-top boxes,
estimating unreported addressable impressions for a plurality of unreported media devices for the addressable advertisement based on an impressions adjustment ratio of the served reportable addressable impressions to the exposed reported addressable impressions,
calculating at least one of reach or frequency for the addressable advertisement to account for the unreported media devices, the at least one of the reach or the frequency determined based on the exposed reported addressable impressions, the estimated unreported addressable impressions, and the impressions adjustment ratio, and
transmitting the at least one of the reach or the frequency to a computer database.

2. The computing system of claim 1, wherein the reference advertisement data identifies which households were served the addressable advertisement.

3. The computing system of claim 1, wherein estimating the unreported addressable impressions comprises estimating the unreported addressable impressions by applying the impressions adjustment ratio to the exposed reported addressable impressions.

4. The computing system of claim 1, wherein calculating the at least one of the reach or the frequency comprises determining total campaign impressions for the addressable advertisement by determining a sum of the exposed reported addressable impressions and the estimated unreported addressable impressions.

5. The computing system of claim 1, wherein calculating the at least one of the reach or the frequency comprises calculating a total reach by determining a sum of a first reach across reported households associated with the reporting media devices and a second reach across unreported households associated with the unreported media devices.

6. The computing system of claim 1, wherein transmitting the at least one of the reach or the frequency to the computer database comprises reporting the at least one of the reach or the frequency to an advertisement provider of the addressable advertisement.

7. The computing system of claim 1, further comprising the multiple media meters.

8. The computing system of claim 7, wherein the multiple media meters are configured to monitor media exposure based on audio detected by the multiple media meters.

9. A method comprising:
receiving, via a network interface of a computing system, monitoring data collected by multiple media meters which monitor media exposure associated with panelist media devices in panel homes recruited by an audience measurement entity;
receiving, via the network interface, automatic content recognition (ACR) data collected by multiple smart televisions which monitor media exposure in smart television households;
receiving, via the network interface, return path data (RPD) collected by a media service provider, the RPD including tuning events associated with set-top boxes in RPD households;
receiving, via the network interface, reference advertisement data collected by an advertisement provider system for an addressable advertisement;
processing, by a data center, the reference advertisement data to identify served reportable addressable impressions associated with ones of the smart televisions or set-top boxes to which the addressable advertisement was served;
processing, by the data center, the monitoring data, ACR data, and the RPD to identify exposed reported addressable impressions associated with presentation of the addressable advertisement by ones of the panelist media devices, smart televisions, or set-top boxes;
estimating, by the data center, unreported addressable impressions for a plurality of unreported media devices for the addressable advertisement based on an impressions adjustment ratio of the served reportable addressable impressions to the exposed reported addressable impressions;
calculating, by the data center, at least one of reach or frequency for the addressable advertisement to account for the unreported media devices, the at least one of the reach or the frequency determined based on the exposed reported addressable impressions, the estimated unreported addressable impressions, and the impressions adjustment ratio; and
transmitting, by the data center, the at least one of the reach or the frequency to a computer database.

10. The method of claim 9, wherein the reference advertisement data identifies which households were served the addressable advertisement.

11. The method of claim 9, wherein estimating the unreported addressable impressions comprises estimating the unreported addressable impressions by applying the impressions adjustment ratio to the exposed reported addressable impressions.

12. The method of claim 9, wherein calculating the at least one of the reach or the frequency comprises determining total campaign impressions for the addressable advertisement by determining a sum of the exposed reported addressable impressions and the estimated unreported addressable impressions.

13. The method of claim 9, wherein calculating the at least one of the reach or the frequency comprises calculating a total reach by determining a sum of a first reach across reported households associated with the reporting media devices and a second reach across unreported households associated with the unreported media devices.

14. The method of claim 9, wherein transmitting the at least one of the reach or the frequency to the computer database comprises reporting the at least one of the reach or the frequency to an advertisement provider of the addressable advertisement.

15. A non-transitory computer-readable medium having stored therein instructions that when executed by a computing system cause the computing system to perform a set of acts comprising:
receiving monitoring data collected by multiple media meters which monitor media exposure associated with panelist media devices in panel homes recruited by an audience measurement entity;
receiving automatic content recognition (ACR) data collected by multiple smart televisions which monitor media exposure in smart television households;
receiving return path data (RPD) collected by a media service provider, the RPD including tuning events associated with set-top boxes in RPD households;
receiving reference advertisement data collected by an advertisement provider system for an addressable advertisement;
processing the reference advertisement data to identify served reportable addressable impressions associated with ones of the smart televisions or set-top boxes to which the addressable advertisement was served;
processing the monitoring data, ACR data, and the RPD to identify exposed reported addressable impressions associated with presentation of the addressable advertisement by ones of the panelist media devices, smart televisions, or set-top boxes;
estimating unreported addressable impressions for a plurality of unreported media devices for the addressable advertisement based on an impressions adjustment ratio of the served reportable addressable impressions to the exposed reported addressable impressions;
calculating at least one of reach or frequency for the addressable advertisement to account for the unreported media devices, the at least one of the reach or the frequency determined based on the exposed reported addressable impressions, the estimated unreported addressable impressions, and the impressions adjustment ratio; and
transmitting the at least one of the reach or the frequency to a computer database.

16. The non-transitory computer-readable medium of claim 15, wherein the reference advertisement data identifies which households were served the addressable advertisement.

17. The non-transitory computer-readable medium of claim 15, wherein estimating the unreported addressable impressions comprises estimating the unreported addressable impressions by applying the impressions adjustment ratio to the exposed reported addressable impressions.

18. The non-transitory computer-readable medium of claim 15, wherein calculating the at least one of the reach or the frequency comprises determining total campaign impressions for the addressable advertisement by determining a sum of the exposed reported addressable impressions and the estimated unreported addressable impressions.

19. The non-transitory computer-readable medium of claim 15, wherein calculating the at least one of the reach or the frequency comprises calculating a total reach by determining a sum of a first reach across reported households associated with the reporting media devices and a second reach across unreported households associated with the unreported media devices.

20. The non-transitory computer-readable medium of claim 15, wherein transmitting the at least one of the reach or the frequency to the computer database comprises reporting the at least one of the reach or the frequency to an advertisement provider of the addressable advertisement.
